(19) United States
(12) Patent Application Publication
(10) Pub. No.: US 2017/0025220 A1
(43) Pub. Date: Jan. 26, 2017

(54) LAMINATION COIL COMPONENT AND COIL MODULE

(71) Applicant: Murata Manufacturing Co., Ltd., Nagaokakyo-shi (JP)

(72) Inventor: Masataka NAKANIWA, Nagaokakyo-shi (JP)

(21) Appl. No.: 15/285,532

(22) Filed: Oct. 5, 2016

Related U.S. Application Data
(63) Continuation of application No. PCT/JP2015/055594, filed on Feb. 26, 2015.

(30) Foreign Application Priority Data
Apr. 9, 2014 (JP) 2014-080017

(51) Int. Cl. H01F 27/28; H01F 27/245

(52) U.S. Cl. CPC H01F 27/2804; H01F 27/245; H01F 2027/2809

(57) ABSTRACT

A multilayer body includes a plurality of magnetic body sheets laminated in a lamination direction. Coil conductors are embedded in the multilayer body to define a coil with a winding axis extending in the lamination direction. The coil conductors define a circle when viewed in the lamination direction. An air gap is provided in a region surrounded by an inner circumferential edge of the circle defined by the coil conductors when viewed in the lamination direction. The coil conductors sandwich the air gap therebetween in the lamination direction and are surrounded by the magnetic body without being exposed to the air gap.

### CROSS REFERENCE TO RELATED APPLICATIONS

This application claims the benefit of priority to Japanese Patent Application No. 2014-080017 filed Apr. 9, 2014 and is a Continuation Application of PCT/JP2015/055594 filed on Feb. 26, 2015. The entire contents of each of these applications are hereby incorporated by reference herein.

### BACKGROUND OF THE INVENTION

1. Field of the Invention

The present invention relates to lamination coil components and coil modules, and particularly relates to a lamination coil component including a multilayer body in which magnetic body layers are laminated and a coil that is embedded in the multilayer body, and a coil module including the lamination coil component.

2. Description of the Related Art

An example of this type of lamination coil component is disclosed in International Publication No. WO 2008/093568, and describes a lamination coil component includes a multilayer body 11 (11a, 11b) in which magnetic layers made of magnetic ceramic layers are laminated. In the multilayer body 11, a spiral coil L including a plurality of electrically connected coil conductors 5 is built-in. A nonmagnetic layer 4 made of a nonmagnetic ceramic layer is disposed at a substantially central position of the coil L in a lamination direction of the multilayer body 11. Providing the nonmagnetic layer in the multilayer body causes the coil L to have, in part, open magnetic circuit-type magnetic field characteristics, wherein a reduction in inductance due to magnetic saturation is suppressed and preferable direct-current superposition characteristics can be obtained.

However, in the above-mentioned related art, since the magnetic ceramic layers and the nonmagnetic ceramic layer are calcined at the same time, a diffusion layer (which is not a nonmagnetic layer) is formed between the magnetic layer and the nonmagnetic layer or the nonmagnetic layer itself is magnetized, wherein a reduction in inductance due to magnetic saturation cannot be sufficiently suppressed. This degrades the direct-current superposition characteristics in some cases. In addition, because the characteristics of the diffusion layer change in accordance with temperatures, the direct-current superposition characteristics also change in accordance with temperatures, wherein the direct-current superposition characteristics are further degraded depending on the temperatures. The problem that the direct-current superposition characteristics change in accordance with the temperatures becomes further complicated as the thickness of the nonmagnetic ceramic layer, the number of layers, and so on are diversified.

### SUMMARY OF THE INVENTION

Preferred embodiments of the present invention provide a lamination coil component capable of improving direct-current superposition characteristics in a stable manner.

A lamination coil component according to a preferred embodiment of the present invention includes a multilayer body in which a plurality of magnetic body layers are laminated and a coil which is embedded in the multilayer body such that a winding axis of the coil extends in a lamination direction, wherein the coil includes a plurality of coil conductors respectively provided in the plurality of magnetic body layers so as to define a circle when viewed in the lamination direction, an air gap is provided in a region surrounded by an inner circumferential edge of the circle defined by the plurality of coil conductors when viewed in the lamination direction, the plurality of coil conductors include two specific coil conductors sandwiching the air gap therebetween in the lamination direction, and the two specific coil conductors are surrounded by the magnetic body layers without being exposed to the air gap.

In a lamination coil component according to a preferred embodiment of the present invention, the air gap extends across two or more of the plurality of coil conductors.

In a lamination coil component according to a preferred embodiment of the present invention, the plurality of coil conductors include one or more additional coil conductors provided at a position overlapping with the air gap in the lamination direction.

In a lamination coil component according to a preferred embodiment of the present invention, the additional coil conductor is exposed to the air gap on an inner circumferential edge side thereof.

In a lamination coil component according to a preferred embodiment of the present invention, the additional coil conductor is exposed to the air gap in the lamination direction.

In a lamination coil component according to a preferred embodiment of the present invention, the air gap has a size which is encompassed within an outer edge of the circle when viewed in the lamination direction.

In a lamination coil component according to a preferred embodiment of the present invention, distances from each of the two specific coil conductors to the air gap in the lamination direction are equal or substantially equal to each other.

In a lamination coil component according to a preferred embodiment of the present invention, the air gap is provided at a plurality of different positions in the lamination direction.

In a lamination coil component according to a preferred embodiment of the present invention, a plurality of wound bodies are embedded as coils in the multilayer body, and distances from each central position of the coils to the air gap in the lamination direction are different among the plurality of wound bodies.

In a lamination coil component according to a preferred embodiment of the present invention, a plurality of wound bodies are embedded as coils in the multilayer body, and the multilayer body includes another air gap between the plurality of wound bodies when viewed in the lamination direction.

A coil module according to a preferred embodiment of the present invention includes a lamination coil component and an integrated circuit (IC) mounted on the lamination coil component, wherein the lamination coil component includes a multilayer body in which a plurality of magnetic body layers are laminated and a coil that is embedded in the multilayer body such that a winding axis of the coil extends in a lamination direction, the coil includes a plurality of coil conductors respectively provided in the plurality of magnetic body layers so as to define a circle when viewed in the lamination direction, an air gap is provided in a region surrounded by an inner circumferential edge of the circle defined by the plurality of coil conductors when viewed in the lamination direction, the plurality of coil conductors include two specific coil conductors sandwiching the air gap therebetween in the lamination direction, and the two specific coil conductors are surrounded by the magnetic body layers without being exposed to the air gap.

In a coil module according to a preferred embodiment of the present invention, the air gap provided in the multilayer body so as to improve the direct-current superposition characteristics is not magnetized by magnetic flux. This makes it possible to improve the direct-current superposition characteristics in a stable manner. In addition, because a variation in the direct-current superposition characteristics with respect to a change in temperature of the multilayer body is able to be easily estimated, an increase in the burden on the designer caused by diversification in thickness of the air gap, the number thereof, and other factors is effectively reduced or prevented.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a cross-sectional view illustrating a basic structure of a lamination coil component according to a preferred embodiment of the present invention.

FIG. 2 is a cross-sectional view illustrating a cross-section of a lamination coil component according to a first preferred embodiment of the present invention.

FIG. 3A is a diagram illustrating a state where via hole conductors are provided in a magnetic green sheet SH11 that becomes a material of the lamination coil component according to the first preferred embodiment of the present invention; FIG. 3B is a diagram illustrating a state where via hole conductors are provided in a magnetic green sheet SH12 that becomes a material of the lamination coil component according to the first preferred embodiment of the present invention; FIG. 3C is a diagram illustrating a state where via hole conductors are provided in a magnetic green sheet SH13 that becomes a material of the lamination coil component according to the first preferred embodiment of the present invention; FIG. 3D is a diagram illustrating a state where via hole conductors are provided in a magnetic green sheet SH14 that becomes a material of the lamination coil component according to the first preferred embodiment of the present invention; FIG. 3E is a diagram illustrating a state where a via hole conductor is provided in a magnetic green sheet SH15 that becomes a material of the lamination coil component according to the first preferred embodiment of the present invention; FIG. 3F is a diagram illustrating a state where via hole conductors are provided in a magnetic green sheet SH16 that becomes a material of the lamination coil component according to the first preferred embodiment of the present invention; FIG. 3G is a diagram illustrating a state where via hole conductors are provided in a magnetic green sheet SH17 that becomes a material of the lamination coil component according to the first preferred embodiment of the present invention; FIG. 3H is a diagram illustrating a state where via hole conductors are provided in a magnetic green sheet SH18 that becomes a material of the lamination coil component according to the first preferred embodiment of the present invention; and FIG. 3I is a diagram illustrating a magnetic green sheet SH19 that becomes a material of the lamination coil component according to the first preferred embodiment of the present invention.

FIG. 4 includes cross-sectional views illustrating cross-sections of the magnetic green sheets SH11 through SH19 shown in FIGS. 3A through 3I, respectively.

FIG. 5A is a diagram illustrating a state where input-output terminals are provided on the magnetic green sheet SH11 that becomes a material of the lamination coil component according to the first preferred embodiment of the present invention; FIG. 5B is a diagram illustrating a state where a coil conductor is provided on the magnetic green sheet SH12 that becomes a material of the lamination coil component according to the first preferred embodiment of the present invention; FIG. 5C is a diagram illustrating a state where a coil conductor is provided on the magnetic green sheet SH13 that becomes a material of the lamination coil component according to the first preferred embodiment of the present invention; FIG. 5D is a diagram illustrating a state where a coil conductor is provided on the magnetic green sheet SH14 that becomes a material of the lamination coil component according to the first preferred embodiment of the present invention; FIG. 5E is a diagram illustrating a state where a coil conductor is provided on the magnetic green sheet SH15 that becomes a material of the lamination coil component according to the first preferred embodiment of the present invention; FIG. 5F is a diagram illustrating a state where a coil conductor is provided on the magnetic green sheet SH16 that becomes a material of the lamination coil component according to the first preferred embodiment of the present invention; FIG. 5G is a diagram illustrating a state where a coil conductor is provided on the magnetic green sheet SH17 that becomes a material of the lamination coil component according to the first preferred embodiment of the present invention; FIG. 5H is a diagram illustrating a state where a coil conductor is provided in the magnetic green sheet SH18 that becomes a material of the lamination coil component according to the first preferred embodiment of the present invention; and FIG. 5I is a diagram illustrating a state where a wiring conductor is provided on the magnetic green sheet SH19 that becomes a material of the lamination coil component according to the first preferred embodiment of the present invention.

FIG. 6 includes cross-sectional views illustrating cross-sections of the magnetic green sheets SH11 through SH19.

FIG. 7A is a diagram illustrating a state where a carbon paste is applied to the magnetic green sheet SH15, and FIG. 7B is a diagram illustrating a state where via hole conductors are provided in the magnetic green sheet SH15.

FIG. 8A is a cross-sectional view illustrating a cross-section of the magnetic green sheet SH15 shown in FIG. 7A, and FIG. 8B is a cross-sectional view illustrating a cross-section of the magnetic green sheet SH15 shown in FIG. 7B.

FIG. 9 is a cross-sectional view illustrating a cross-section of a multilayer body (raw block) obtained by laminating and pressure-bonding the magnetic green sheets SH11 through SH19.

FIG. 10 is a cross-sectional view illustrating a cross-section of a lamination coil component manufactured by calcining the raw block shown in FIG. 9.

FIG. 11 is a cross-sectional view illustrating a cross-section of a lamination coil component according to a second preferred embodiment of the present invention.

FIG. 12A is a cross-sectional view illustrating an A21 cross-section of the lamination coil component shown in FIG. 11, FIG. 12B is a cross-sectional view illustrating a C21 cross-section of the lamination coil component shown in FIG. 11, and FIG. 12C is a cross-sectional view illustrating a B21 cross-section of the lamination coil component shown in FIG. 11.

FIG. 13 is a descriptive diagram for explaining stress generated in the lamination coil component shown in FIG. 11.

FIG. 14 is a cross-sectional view illustrating a cross-section of a lamination coil component according to a third preferred embodiment of the present invention.

FIG. 15A is a diagram illustrating a state where via hole conductors and input-output terminals are provided on a magnetic green sheet SH31 that becomes a material of the lamination coil component according to the third preferred embodiment of the present invention; FIG. 15B is a diagram illustrating a state where via hole conductors and a coil conductor are provided on a magnetic green sheet SH32 that becomes a material of the lamination coil component according to the third preferred embodiment of the present invention; FIG. 15C is a diagram illustrating a state where a carbon paste and via hole conductors are provided in an upper layer of a magnetic green sheet SH33 that becomes a material of the lamination coil component according to the third preferred embodiment of the present invention; FIG. 15D is a diagram illustrating a state where a carbon paste and via hole conductors are provided in a lower layer of the magnetic green sheet SH33 that becomes a material of the lamination coil component according to the third preferred embodiment of the present invention; FIG. 15E is a diagram illustrating a state where via hole conductors and a coil conductor are provided on a magnetic green sheet SH34 that becomes a material of the lamination coil component according to the third preferred embodiment of the present invention; and FIG. 15F is a diagram illustrating a state where a wiring conductor is provided on a magnetic green sheet SH35 that becomes a material of the lamination coil component according to the third preferred embodiment of the present invention.

FIG. 16A is a diagram illustrating a manufacturing process of the lower surface of the magnetic green sheet SH33, FIG. 16B is a diagram illustrating a manufacturing process of the upper layer of the magnetic green sheet SH33, and FIG. 16C is a diagram illustrating a process of forming a via hole conductor in the magnetic green sheet SH33.

FIG. 17 includes cross-sectional views illustrating cross-sections of the magnetic green sheets SH31 through SH35.

FIG. 18 is a cross-sectional view illustrating a cross-section of a multilayer body (raw block) obtained by laminating and pressure-bonding the magnetic green sheets SH31 through SH35.

FIG. 19 is a cross-sectional view illustrating a cross-section of a lamination coil component manufactured by calcining the raw block shown in FIG. 18.

FIG. 20 is a cross-sectional view illustrating a cross-section of a lamination coil component according to a fourth preferred embodiment of the present invention.

FIG. 21A is a cross-sectional view illustrating an A42 cross-section of the lamination coil component shown in FIG. 20, FIG. 21B is a cross-sectional view illustrating an A41 cross-section of the lamination coil component shown in FIG. 20, FIG. 21C is a cross-sectional view illustrating an AG41 cross-section of the lamination coil component shown in FIG. 20, FIG. 21D is a cross-sectional view illustrating a B41 cross-section of the lamination coil component shown in FIG. 20, and FIG. 21E is a cross-sectional view illustrating a B42 cross-section of the lamination coil component shown in FIG. 20.

FIG. 22 is a cross-sectional view illustrating a cross-section of a lamination coil component according to a fifth preferred embodiment of the present invention.

FIG. 23A is a cross-sectional view illustrating an A52 cross-section of the lamination coil component shown in FIG. 22, FIG. 23B is a cross-sectional view illustrating an A51 cross-section of the lamination coil component shown in FIG. 22, FIG. 23C is a cross-sectional view illustrating an AG51 cross-section of the lamination coil component shown in FIG. 22, FIG. 23D is a cross-sectional view illustrating a B51 cross-section of the lamination coil component shown in FIG. 22, and FIG. 23E is a cross-sectional view illustrating a B52 cross-section of the lamination coil component shown in FIG. 22.

FIG. 24 is a cross-sectional view illustrating a cross-section of a lamination coil component according to a sixth preferred embodiment of the present invention.

FIG. 25A is a cross-sectional view illustrating an A62 cross-section of the lamination coil component shown in FIG. 24, FIG. 25B is a cross-sectional view illustrating an A61 cross-section of the lamination coil component shown in FIG. 24, FIG. 25C is a cross-sectional view illustrating an AG61 cross-section of the lamination coil component shown in FIG. 24, FIG. 25D is a cross-sectional view illustrating a B61 cross-section of the lamination coil component shown in FIG. 24, and FIG. 25E is a cross-sectional view illustrating a B62 cross-section of the lamination coil component shown in FIG. 24.

FIG. 26 is a cross-sectional view illustrating a cross-section of a lamination coil component according to a seventh preferred embodiment of the present invention.

FIG. 27A is a cross-sectional view illustrating an A71 cross-section of the lamination coil component shown in FIG. 26, FIG. 27B is a cross-sectional view illustrating a C71 cross-section of the lamination coil component shown in FIG. 26, and FIG. 27C is a cross-sectional view illustrating a B71 cross-section of the lamination coil component shown in FIG. 26.

FIG. 28 is a cross-sectional view illustrating a cross-section of a lamination coil component according to an eighth preferred embodiment of the present invention.

FIG. 29A is a cross-sectional view illustrating an A82 cross-section of the lamination coil component shown in FIG. 28, FIG. 29B is a cross-sectional view illustrating an A81 cross-section of the lamination coil component shown in FIG. 28, FIG. 29C is a cross-sectional view illustrating an AG81 cross-section of the lamination coil component shown in FIG. 28, FIG. 29D is a cross-sectional view illustrating a B81 cross-section of the lamination coil component shown in FIG. 28, and FIG. 29E is a cross-sectional view illustrating a B82 cross-section of the lamination coil component shown in FIG. 28.

FIG. 30 is a cross-sectional view illustrating a cross-section of a lamination coil component according to a ninth preferred embodiment of the present invention.

FIG. 31 is a cross-sectional view illustrating a cross-section of a lamination coil component according to a tenth preferred embodiment of the present invention.

FIG. 32A is a diagram illustrating a state where via hole conductors and input-output terminals are provided on a magnetic green sheet SH101 that becomes a material of the lamination coil component according to the tenth preferred embodiment of the present invention; FIG. 32B is a diagram illustrating a state where via hole conductors and a coil conductor are provided on a magnetic green sheet SH102 that becomes a material of the lamination coil component according to the tenth preferred embodiment of the present invention; FIG. 32C is a diagram illustrating a state where via hole conductors and a coil conductor are provided on a magnetic green sheet SH103 that becomes a material of the lamination coil component according to the tenth preferred embodiment of the present invention; FIG. 32D is a diagram illustrating a state where via hole conductors and a coil conductor are provided on a magnetic green sheet SH104 that becomes a material of the lamination coil component according to the tenth preferred embodiment of the present invention; FIG. 32E is a diagram illustrating a state where a carbon paste, via hole conductors, and a coil conductor are provided on a magnetic green sheet SH105 that becomes a material of the lamination coil component according to the tenth preferred embodiment of the present invention; FIG. 32F is a diagram illustrating a state where a carbon paste, via hole conductors, and a coil conductor are provided on a magnetic green sheet SH106 that becomes a material of the lamination coil component according to the tenth preferred embodiment of the present invention; FIG. 32G is a diagram illustrating a state where via hole conductors and a coil conductor are provided on a magnetic green sheet SH107 that becomes a material of the lamination coil component according to the tenth preferred embodiment of the present invention; FIG. 32H is a diagram illustrating a state where via hole conductors and a coil conductor are provided on a magnetic green sheet SH108 that becomes a material of the lamination coil component according to the tenth preferred embodiment of the present invention; and FIG. 32I is a diagram illustrating a state where a wiring conductor is provided on a magnetic green sheet SH109 that becomes a material of the lamination coil component according to the tenth preferred embodiment of the present invention.

FIG. 33A is a diagram illustrating a process of forming a through-hole and a coil conductor on the magnetic green sheet SH105, FIG. 33B is a diagram illustrating a process of forming a coil conductor on the magnetic green sheet SH106, FIG. 33C is a diagram illustrating a process of laminating the magnetic green sheet SH105 on the magnetic green sheet SH106, FIG. 33D is a diagram illustrating a process of applying a carbon paste onto a multilayer body of the magnetic green sheets SH105 and SH106, and FIG. 33E is a diagram illustrating a process of forming a via hole conductor in the multilayer body of the magnetic green sheets 5105 and 5106.

FIG. 34 includes cross-sectional views illustrating cross-sections of the magnetic green sheets SH101 through SH109.

FIG. 35 is a cross-sectional view illustrating a cross-section of a multilayer body (raw block) obtained by laminating and pressure-bonding the magnetic green sheets SH101 through SH109.

FIG. 36 is a cross-sectional view illustrating a cross-section of a lamination coil component manufactured by calcining the raw block shown in FIG. 35.

FIG. 37 is a cross-sectional view illustrating a cross-section of a coil module according to a preferred embodiment of the present invention.

FIG. 38 is a cross-sectional view illustrating a cross-section of a coil module according to another preferred embodiment of the present invention.

FIG. 39 is a cross-sectional view illustrating a cross-section of a coil module according to still another preferred embodiment of the present invention.

FIG. 40 is a cross-sectional view illustrating another cross-section of the coil module shown in FIG. 39.

### DETAILED DESCRIPTION OF THE PREFERRED EMBODIMENTS

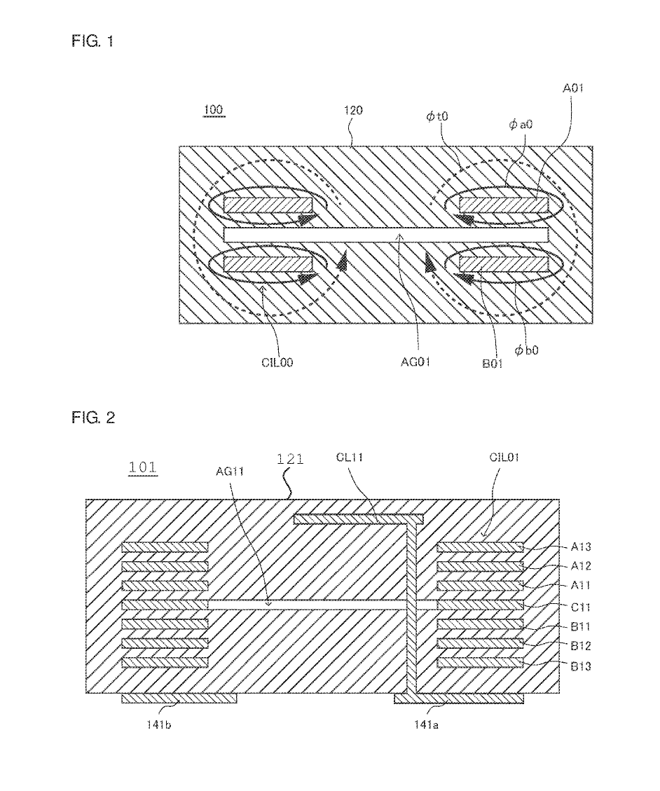

A basic structure of a preferred embodiment of the present invention is illustrated in FIG. 1. A lamination coil component 100 includes a multilayer body 120 in which a plurality of magnetic body sheets are laminated. Preferably, the magnetic body sheets are each made of a ceramic sheet, for example, and the multilayer body 120 is a ceramic multilayer body in which magnetic ceramic layers are laminated. A coil conductor B01 and a coil conductor A01, each of which has a band shape, are embedded in the multilayer body 120. The coil conductor B01 is provided at a position on a lower side relative to a central position in a lamination direction, while the coil conductor A01 is provided at a position on an upper side relative to the central position in the lamination direction. The coil conductors B01 and A01 preferably define a circle when viewed in the lamination direction. Further, the coil conductors B01 and A01 are connected in series so as to define a single coil CIL00. Accordingly, preferably, the coil CIL00 is embedded in the multilayer body 120 such that a winding axis thereof preferably extends in the lamination direction.

An air gap AG01 is provided at the central position in the lamination direction. A formation region of the air gap AG01 preferably extends across the entire or substantially the entire region surrounded by an outer circumferential edge of the circle defined by the coil conductors B01 and A01. The air gap AG01 is sandwiched between the coil conductors B01 and A01 in the lamination direction, and the coil conductors B01 and A01 are surrounded by the magnetic body without being exposed to the air gap AG01.

Because a total magnetic flux φt0 generated by the coil conductors A01 and B01 is blocked or reduced by the air gap AG01, the majority of flux that appears in the multilayer body 120 is the partial magnetic flux φa0 and the partial magnetic flux φb0 individually generated by the coil conductors A01 and B01. Because of this, a reduction in an inductance value due to magnetic saturation is effectively reduced or prevented and the direct-current superposition characteristics are significantly improved.

Further, in the lamination coil component 100, because the air gap AG01, instead of a nonmagnetic ceramic layer, is provided at a position sandwiched between the coil conductors A01 and B01 in the lamination direction, a diffusion layer is not formed, thus stabilizing the direct-current superposition characteristics. Furthermore, because a variation in the direct-current superposition characteristics with respect to a change in temperature of the multilayer body 120 is able to be easily estimated, an increase in burden on the designer brought by the diversification in thickness of the air gap, the number thereof, and so on is prevented.

### First Preferred Embodiment

Referring to FIG. 2, a lamination coil component (LGA inductor) 101 according to a first preferred embodiment of the present invention includes a multilayer body 121 in which a plurality of magnetic body sheets are laminated. A coil conductor B13, a coil conductor B12, a coil conductor (a first coil conductor) B11, a coil conductor (additional coil conductor) C11, a coil conductor (a second coil conductor) A11, a coil conductor A12, and a coil conductor A13, each of which preferably has a band shape, for example, are embedded in the multilayer body 121. In addition, a wiring conductor CL11 is also embedded therein.

Preferably, the coil conductors B13, B12, B11, C11, A11, A12, and A13 are aligned or substantially aligned in that order in the lamination direction, and are connected in series so as to define a single coil CIL01. The coil conductors B13, B12, B11, A11, A12, and A13 preferably define a circle when viewed in the lamination direction, and the coil conductor C11 extends along the circle. The coil CIL01 is embedded in the multilayer body 121 such that a winding axis thereof preferably extends in the lamination direction. Input-output terminals 141a and 141b are provided on a lower surface of the multilayer body 121. One end of the coil CIL01 is connected to the input-output terminal 141b through a via hole conductor VH11b to be explained later, while the other end of the coil CIL01 is connected to the input-output terminal 141a through the wiring conductor CL11 and via hole conductors VH11a through VH18a to be explained later.

An air gap AG11 is provided at a central position in the lamination direction, and preferably at the same height position as the coil conductor C11. More specifically, the air gap AG11 is provided in a region surrounded by an inner circumferential edge of the circle drawn by the coil conductors B13, B12, A11, A12, and A13 (excluding the via hole conductors) when viewed in the lamination direction. In the present preferred embodiment, a thickness of the air gap AG11 is preferably equal or substantially equal to a thickness of the coil conductor C11. The coil conductor C11 is exposed to the air gap AG11 on the inner circumferential edge side thereof. The air gap AG11 is positioned between the coil conductors B11 and A11 in the lamination direction, and the coil conductors B11 and A11 are surrounded by the magnetic body layers without being exposed to the air gap AG11.

In the present preferred embodiment, the air gap AG11 significantly improves the direct-current superposition characteristics in a stable manner. Further, in this preferred embodiment, the coil conductor C11 is provided at the same or substantially the same height position as the air gap AG11, which makes it possible to increase the number of coil inductor turns and increase an inductance value of the coil CIL01 while reducing the height of the multilayer body 121.

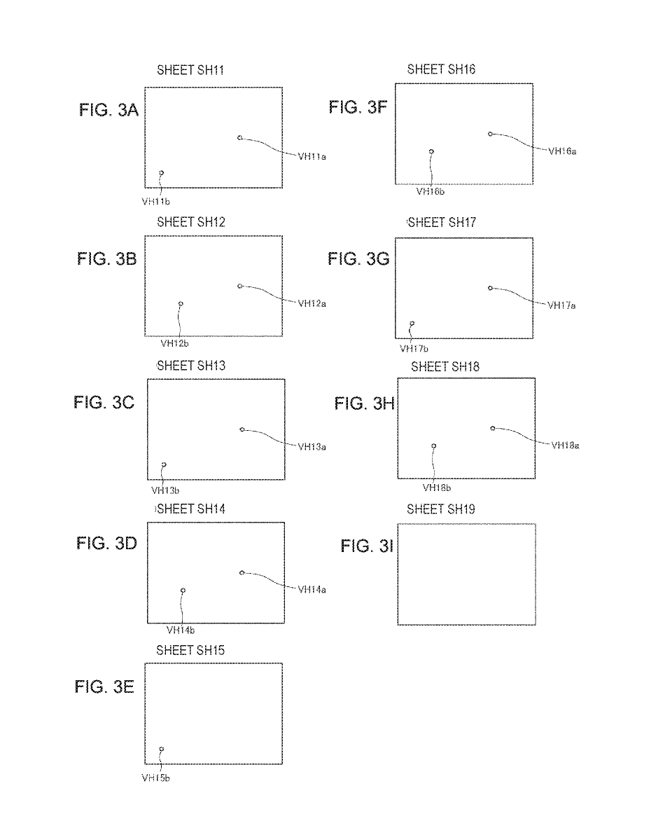

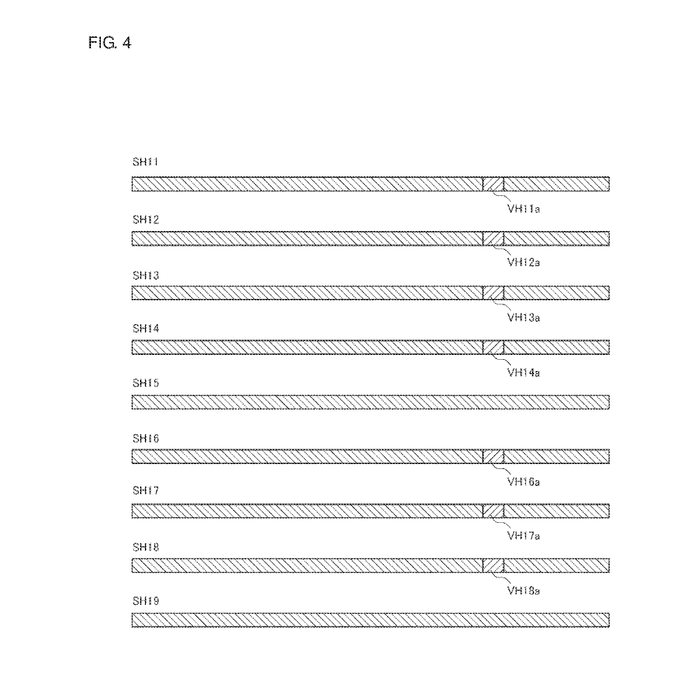

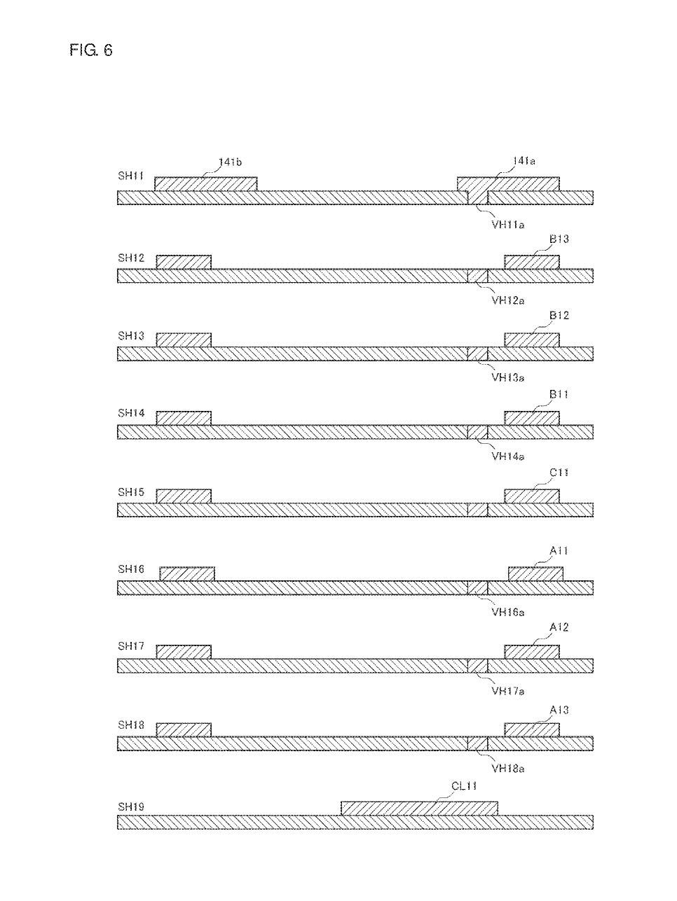

The lamination coil component 101 according to the present preferred embodiment is preferably manufactured in the following manner, for example. Referring to FIGS. 3A through 31 and FIG. 4, magnetic green sheets (magnetic body layers) SH11 through SH19 are prepared first, through-holes are formed by laser in the magnetic green sheets SH11 through SH18 at predetermined positions, and then the through-holes having been formed are filled with a conductive paste.

Through this process, the via hole conductors VH11a and VH11b are formed in the magnetic green sheet SH11, the via hole conductor VH12a and a via hole conductor VH12b are formed in the magnetic green sheet SH12, the via hole conductor VH13a and a via hole conductor VH13b are formed in the magnetic green sheet SH13, the via hole conductor VH14a and a via hole conductor VH14b are formed in the magnetic green sheet SH14. Further, a via hole conductor VH15b is formed in the magnetic green sheet SH15, the via hole conductor VH16a and a via hole conductor VH16b are formed in the magnetic green sheet SH16, the via hole conductor VH17a and a via hole conductor VH17b are formed in the magnetic green sheet SH17, and the via hole conductor VH18a and a via hole conductor VH18b are formed in the magnetic green sheet SH18.

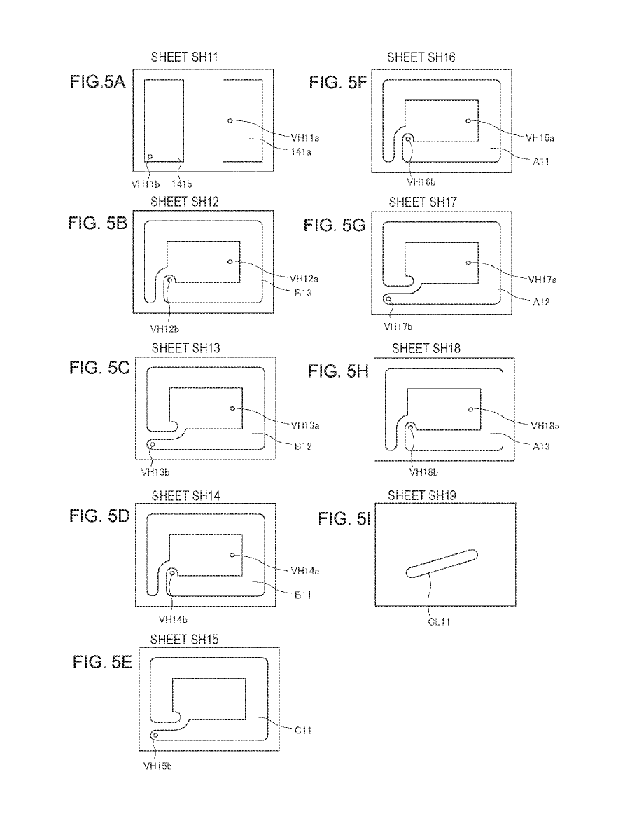

Next, a conductive paste is applied onto one surface (an upper surface as shown in FIGS. 5A through 51 and FIG. 6) of the magnetic green sheets SH11 through SH19 in the manner as shown in FIGS. 5A through 51 and FIG. 6. As a result, the input-output terminals 141a and 141b are formed on the magnetic green sheet SH11, the coil conductors B13, B12, B11, C11, A11, A12, and A13 are formed on the magnetic green sheets SH12 through SH18, respectively, and the wiring conductor CL11 is formed on the magnetic green sheet SH19.

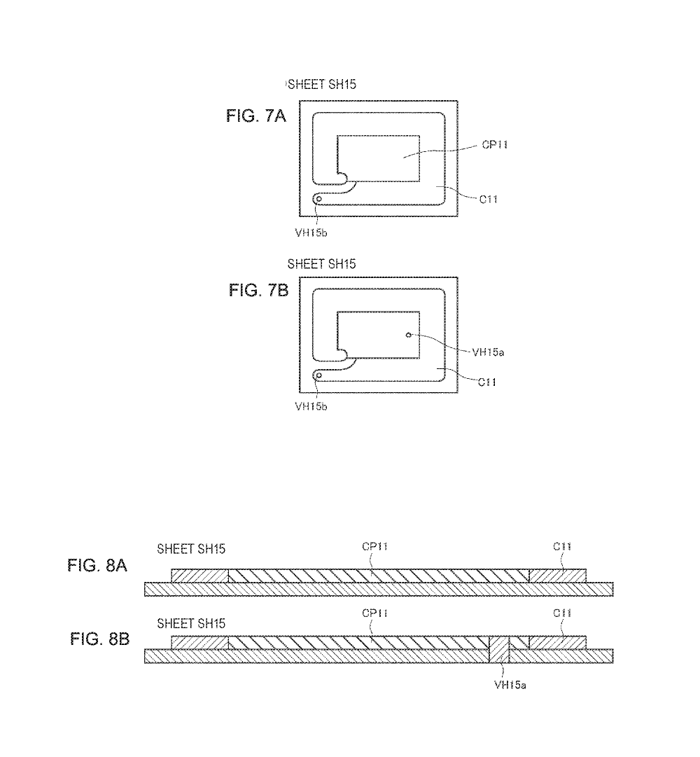

Thereafter, a carbon paste CP11 is applied to an opening region (a region surrounded by the inner circumferential edge of the circle defined by the coil conductors B13, B12, B11, C11, A11, A12, and A13 in the lamination direction) of the coil conductor C11 provided on the magnetic green sheet SH15 (see FIGS. 7A and 8A). Further, the magnetic green sheet SH15 is irradiated with a laser beam at a predetermined position to form a through-hole therein, and the through-hole having been formed is filled with the conductive paste (see FIG. 7(B) and FIG. 8(B)). Through this process, the via hole conductor VH15a is formed in the magnetic green sheet SH15.

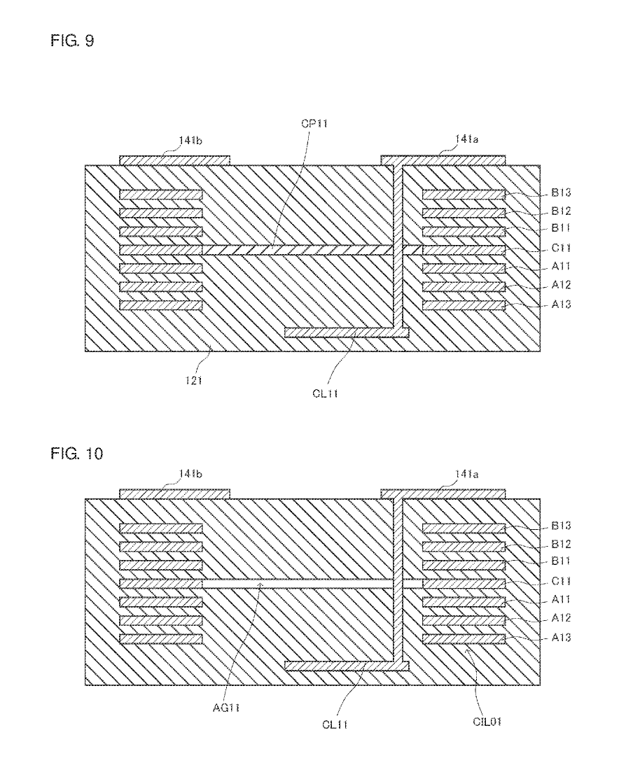

A multilayer body (raw block) shown in FIG. 9 is obtained by laminating the magnetic green sheets SH11 through SH19 having been manufactured as discussed above in that order and pressure-bonding them. Calcining the raw block causes the magnetic green sheets SH11 through SH19 and the conductive paste to be sintered and further causes the carbon paste CP11 to burn and vanish. As a result, the lamination coil component 101 including the air gap AG11 is completed in the manner as shown in FIG. 10.

### Second Preferred Embodiment

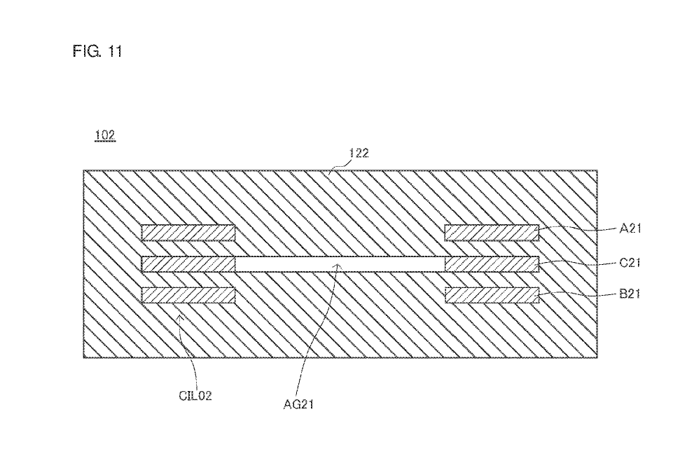

Referring to FIG. 11, a lamination coil component (LGA inductor) 102 according to a second preferred embodiment of the present invention includes a multilayer body 122 in which a plurality of magnetic body sheets are laminated. A coil conductor (first coil conductor) B21, a coil conductor (additional coil conductor) C21, and a coil conductor (second coil conductor) A21, each of which preferably has a band shape, for example, are embedded in the multilayer body 122. Preferably, the coil conductors B21, C21, and A21 are aligned or substantially aligned in the lamination direction in that order, and are connected in series to define a single coil CIL02. Preferably, the coil conductors B21 and A21 define a circle when viewed in the lamination direction, and the coil conductor C21 extends along the circle. As such, the coil CIL02 is preferably embedded in the multilayer body 122 such that a winding axis thereof preferably extends in the lamination direction.

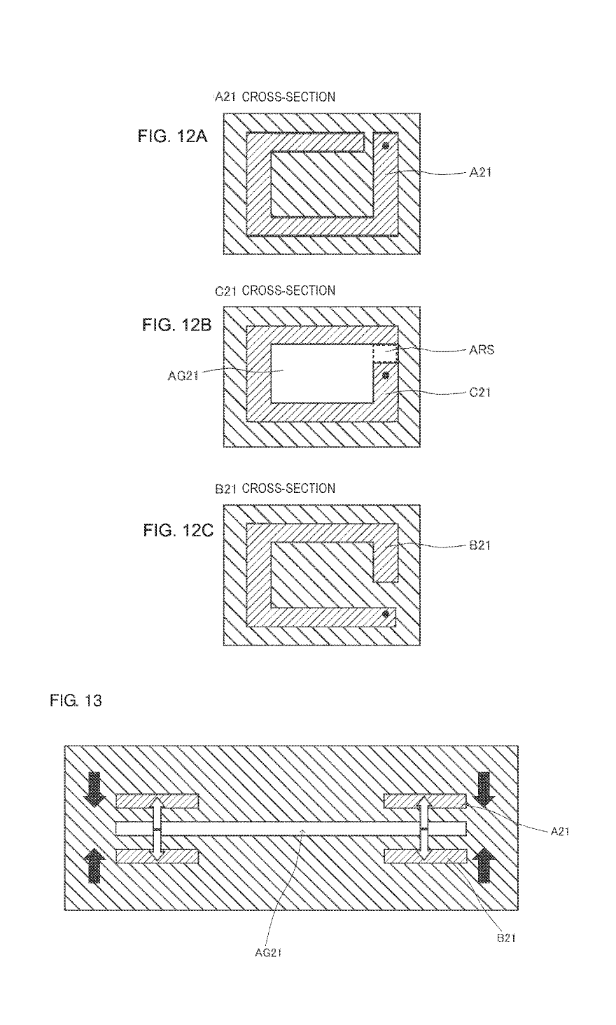

FIG. 12A illustrates an A21 cross-section of the multilayer body 122 at a height position at which the coil conductor A21 is located, FIG. 12B illustrates a C21 cross-section of the multilayer body 122 at a height position at which the coil conductor C21 is located, and FIG. 12C illustrates a B21 cross-section of the multilayer body 122 at a height position at which the coil conductor B21 is located.

An air gap AG21 is preferably provided at a central position in the lamination direction, i.e., at the same height position as the coil conductor C21. To be specific, the air gap AG21 is provided in a region surrounded by an inner circumferential edge of the circle defined by the coil conductors B21 and A21 when viewed in the lamination direction. Further, the air gap AG21 also extends to a region ARS (see FIG. 12B) where the coil conductor C21 is not present and the coil conductors B21 and A21 are present when viewed in the lamination direction. A thickness of the air gap AG21 is preferably equal or substantially equal to a thickness of the coil conductor C21, for example. The coil conductor C21 is exposed to the air gap AG21 on the inner circumferential edge side thereof.

A distance from the air gap AG21 to the coil conductor A21 in the lamination direction is preferably equal or substantially equal to a distance from the air gap AG21 to the coil conductor B21 in the lamination direction, for example. The air gap AG21 is positioned between the coil conductors B21 and A21 in the lamination direction, and the coil conductors B21 and A21 are surrounded by the magnetic body without being exposed to the air gap AG21.

In the present preferred embodiment, because the air gap AG21 is also provided in the region ARS where the coil conductor C21 is not present and the coil conductors B21 and A21 are present when viewed in the lamination direction, the total magnetic flux generated by the coil conductors A21, B21, and C21 is further reduced and the direct-current superposition characteristics are further improved.

Further, by encompassing an outer circumferential edge of the air gap AG21 within an outer circumferential edge of the circle defined by the coil conductors B21 and A21 when viewed in the lamination direction, the generation of a crack in the magnetic body is effectively prevented during calcination. That is, in the case where the outer circumferential edge of the air gap AG21 extends outward from the outer circumferential edge of the circle defined by the coil conductors A21 and B21, a crack is likely to be generated during calcination in a magnetic body portion between the air gap AG21 and an outer side portion surface of the multilayer body 122. However, by providing the air gap AG21 in the manner discussed above, the generation of the crack is effectively prevented. Furthermore, because the distance from the air gap AG21 to the coil conductor A21 is equal or substantially equal to the distance from the air gap AG21 to the coil conductor B21, the generation and development of the crack is even more effectively prevented.

As for cracks, the following facts are understood from a result of a stress simulation: (1) a strong compression stress is generated in the longitudinal direction near the outer side portion of the outer circumferential edge of the coil; and (2) a tensile stress is generated in the longitudinal direction between two coil conductors adjacent to each other. This will be described below with reference to FIG. 13. Note that in FIG. 13, for the sake of convenience in explanation, the coil conductor C21 is omitted and the air gap AG21 is provided in a region surrounded by the outer circumferential edge of the circle defined by the coil conductors B21 and A21.

When the coil conductors A21 and B21 are not present on the upper and lower sides of the outer circumferential edge of the air gap AG21, a compression stress in the longitudinal direction becomes smaller due to the air gap AG21, such that a crack is likely to be generated in a magnetic body portion located in an external direction from the air gap AG21 when viewed in the lamination direction. Conversely, where the coil conductors A21 and B21 are present on the upper and lower sides of the outer circumferential edge of the air gap AG21 when viewed in the lamination direction, a crack is unlikely to be generated in the external direction from the air gap AG21 due to a strong compression stress around the coil conductors B21 and A21.

Moreover, a tensile stress is concentrated at a central position in the lamination direction between the coil conductors B21 and A21. As such, in order to reduce the stress, it is preferable that the air gap AG21 be provided at a portion on which the stress is concentrated, that is, at the central position between the coil conductors B21 and A21.

### Third Preferred Embodiment

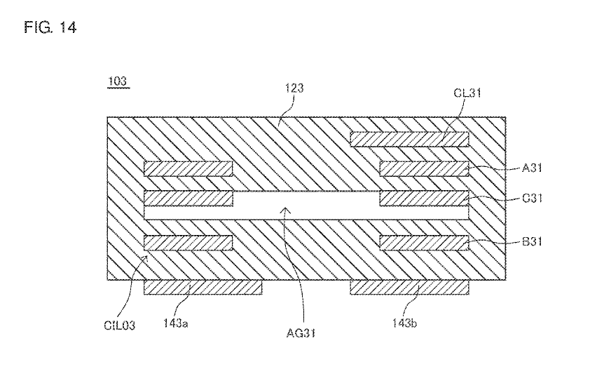

Referring to FIG. 14, a lamination coil component (LGA inductor) 103 according to a third preferred embodiment of the present invention preferably includes a multilayer body 123 in which a plurality of magnetic body sheets are laminated. A coil conductor (specific coil conductor) B31, a coil conductor (additional coil conductor) C31, and a coil conductor (specific coil conductor) A31, each of which preferably has a band shape, for example, are embedded in the multilayer body 123. In addition, a wiring conductor CL31 is also embedded in the multilayer body 123. Preferably, the coil conductors B31, C31, and A31 are aligned or substantially aligned in the lamination direction in that order, and are connected in series to define a single coil CIL03. The coil conductors B31 and A31 preferably define a circle when viewed in the lamination direction, and the coil conductor C31 extends along the circle. As such, the coil CIL03 is embedded in the multilayer body 123 such that a winding axis thereof preferably extends in the lamination direction.

Input-output terminals 143a and 143b are provided on a lower surface of the multilayer body 123. One end of the coil CIL03 is directly connected to the input-output terminal 143a, while the other end of the coil CIL03 is connected to the input-output terminal 143b through the wiring conductor CL31.

Preferably, an air gap AG31 is provided at a central position in the lamination direction, i.e., at a height position being adjacent to the coil conductor 31 on a lower side of the coil conductor C31, and at the same or substantially the same height position as the coil conductor C31. More specifically, at the height position being adjacent to the coil conductor C31 on the lower side of the coil conductor C31, the air gap AG31 is preferably provided in a region surrounded by an outer circumferential edge of the circle defined by the coil conductors B31 and A31 when viewed in the lamination direction. Meanwhile, at the same or substantially the same height position as the coil conductor C31, the air gap AG31 is provided in a region surrounded by an inner circumferential edge of the circle defined by the coil conductors B31 and A31 when viewed in the lamination direction, and further extends to a region where the coil conductor C31 is not present and the coil conductors B31 and A31 are present when viewed in the lamination direction. With this configuration, the lower surface side (lamination direction side) and the inner circumferential edge side of the coil conductor C31 are exposed to the air gap AG31, as shown in FIG. 14. The air gap AG31 is positioned between the coil conductors B31 and A31 in the lamination direction, and the coil conductors B31 and A31 are surrounded by the magnetic body layers without being exposed to the air gap AG31.

In the present preferred embodiment, because a size of the air gap AG31 is larger than that of the air gap AG21, the direct-current characteristics are further improved.

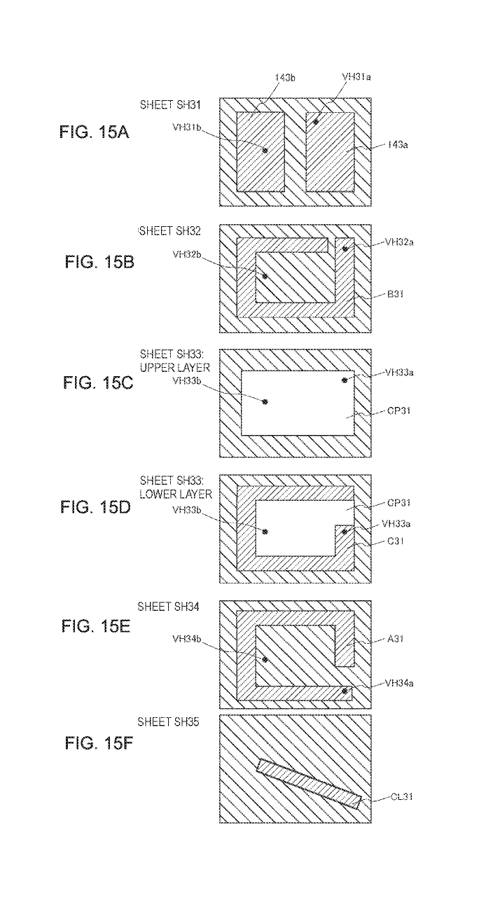

The lamination coil component 103 according to the present preferred embodiment is preferably manufactured in the following manner, for example. Referring to FIGS. 15A through 15F, magnetic green sheets SH31 through SH35 are prepared first; subsequently, through-holes are formed in the magnetic green sheets SH31, SH32, and SH34 by laser at predetermined positions; and then the through-holes having been formed are filled with a conductive paste.

Through this process, via hole conductors VH31a and VH31b are formed in the magnetic green sheet SH31, via hole conductors VH32a and VH32b are formed in the magnetic green sheet SH32, and via hole conductors VH34a and VH34b are formed in the magnetic green sheet SH34.

Subsequently, a conductive paste is applied onto the magnetic green sheets SH31, SH32, SH34, and SH35. As a result, the input-output terminals 143a and 143b are formed on the magnetic green sheet SH31, the coil conductors B31 and A31 are formed on the magnetic green sheets SH32 and SH34, respectively, and the wiring conductor CL31 is formed on the magnetic green sheet SH35.

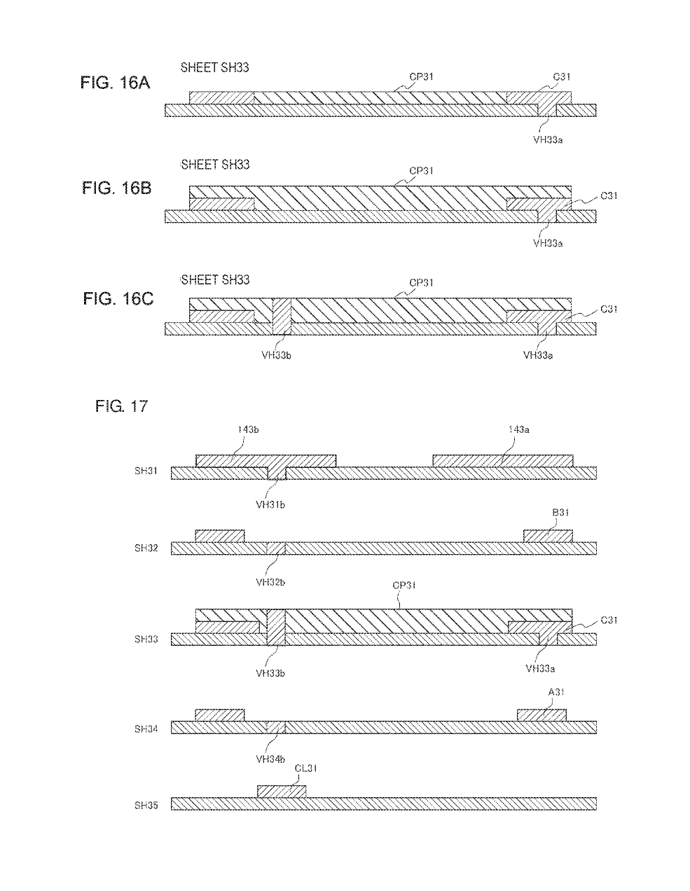

As for the magnetic green sheet SH33, a through-hole is formed by laser at a predetermined position first, and then the through-hole having been formed is filled with a conductive paste. With this process, a via hole conductor VH33a is formed in the manner as shown in FIG. 15D and FIG. 16A. Next, a conductive paste corresponding to the coil conductor C31 is applied onto the magnetic green sheet SH33 (see FIG. 15D and FIG. 16A). Subsequently, a carbon paste CP31 is applied to a region where the air gap AG31 is to be formed (see FIG. 16A), and the carbon paste CP31 is further applied so as to cover the coil conductor C31 (see FIG. 16B). The carbon paste CP31 may be formed in a single application process.

Thereafter, a through-hole is formed by irradiating the magnetic green sheet SH33 with a laser beam at a predetermined position, and the through-hole having been formed is filled with a conductive paste. With this process, a via hole conductor VH33b is formed in the magnetic green sheet SH33 and at the position where the carbon paste CP31 is applied (see FIGS. 15C and 15D, and FIG. 16C).

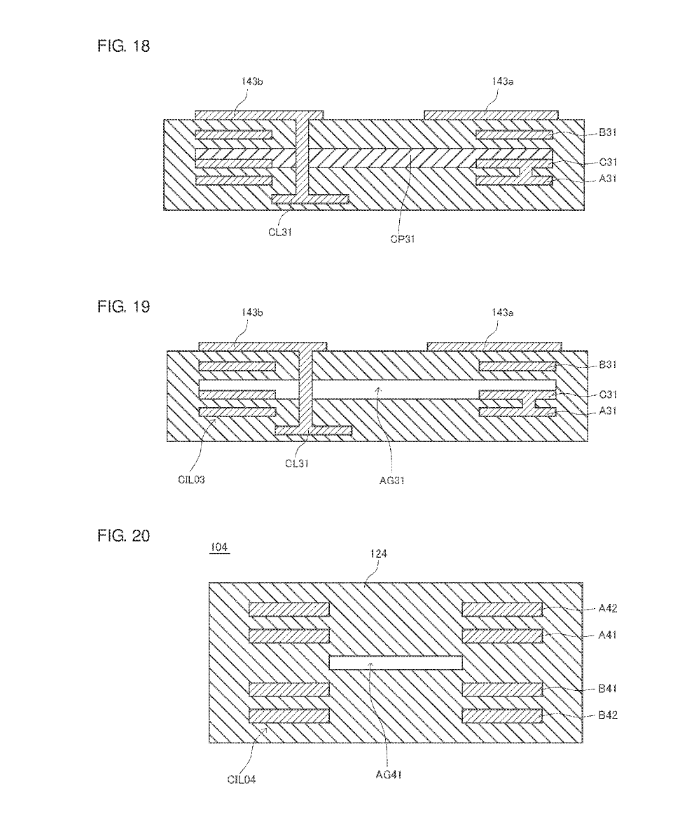

With the above process, the magnetic green sheets SH31 through SH35 shown in FIG. 17 are obtained. A multilayer body (raw block) shown in FIG. 18 is obtained by laminating the magnetic green sheets SH31 through SH35 shown in FIG. 17 in that order and pressure-bonding them. Calcining the raw block causes the magnetic green sheets SH31 through SH35 and the conductive paste to be sintered and further causes the carbon paste CP31 to burn and vanish. As a result, the lamination coil component 103 including the air gap AG31 is completed in the manner as shown in FIG. 19.

### Fourth Preferred Embodiment

Referring to FIG. 20, a lamination coil component (LGA inductor) 104 according to a fourth preferred embodiment of the present invention preferably includes a multilayer body 124 in which a plurality of magnetic body sheets are laminated. In the multilayer body 124, there are embedded a coil conductor B42 and a coil conductor (first coil conductor) B41, each of which preferably has a band shape, for example, and a band-shaped coil conductor (second coil conductor) A41 and a band-shaped coil conductor A42.

Note that in FIG. 20 through FIG. 29 referred to in the fourth through eighth preferred embodiments of the present invention, wiring conductors, input-output terminals, and the like are omitted and only the principal structures are illustrated.

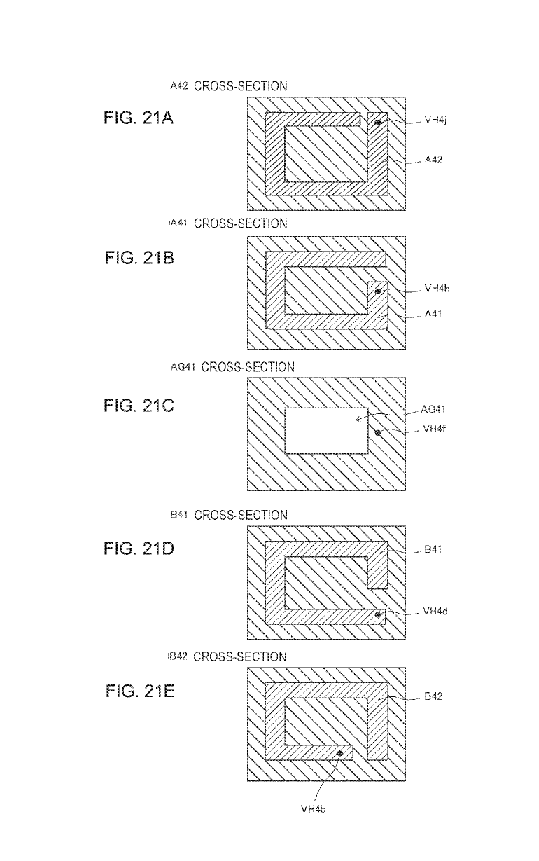

As shown in FIGS. 21A through 21E, preferably, the coil conductors A42, A41, B41, and B42 have the same or substantially the same line width and outer shape, are aligned or substantially aligned in the lamination direction in that order, and are connected in series through via hole conductors VH4j, VH4h, VH4f, and VH4d. With this configuration, a coil CIL04 is provided. At least the coil conductors A41 and B41 preferably define a circle when viewed in the lamination direction. The coil CIL04 is embedded in the multilayer body 124 such that a winding axis thereof preferably extends in the lamination direction. One end of the coil CIL04 communicates with the exterior of the multilayer body 124 through the via hole conductor VH4b, while the other end of the CIL04 communicates with the exterior of the multilayer body 124 through a via hole conductor (not shown).

An air gap AG41 is provided at a central position in the lamination direction. More specifically, the air gap AG41 is preferably provided in a region surrounded by an inner circumferential edge of the circle defined by the coil conductors A41 and B41 when viewed in the lamination direction. A distance from the air gap AG41 to the coil conductor A41 is preferably equal to or substantially equal a distance from the air gap AG41 to the coil conductor B41, for example. Further, the air gap AG41 is positioned between the coil conductors B41 and A41 in the lamination direction, and the coil conductors B41 and A41 are surrounded by the magnetic body layers without being exposed to the air gap AG41.

FIG. 21A illustrates an A42 cross-section of the multilayer body 124 at a height position at which the coil conductor A42 is present, FIG. 21B illustrates an A41 cross-section of the multilayer body 124 at a height position at which the coil conductor A41 is present, and FIG. 21C illustrates an AG41 cross-section of the multilayer body 124 at a height position at which the air gap AG41 is present. Further, FIG. 21D illustrates a B41 cross-section of the multilayer body 124 at a height position at which the coil conductor B41 is present, and FIG. 21E illustrates a B42 cross-section of the multilayer body 124 at a height position at which the coil conductor B42 is present.

In the present preferred embodiment, because a formation region of the air gap AG41 is encompassed within a region surrounded by the inner circumferential edge of the circle defined by the coil conductors A41 and B41 when viewed in the lamination direction, the generation of a crack during calcination is effectively reduced or prevented.

### Fifth Preferred Embodiment

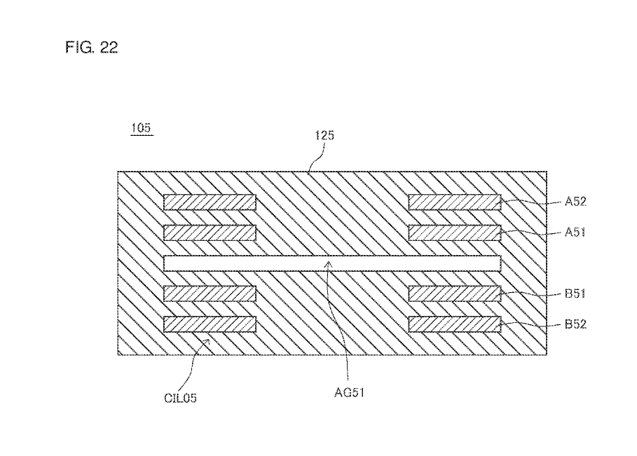

Referring to FIG. 22, a lamination coil component (LGA inductor) 105 according to a fifth preferred embodiment of the present invention preferably includes a multilayer body 125 in which a plurality of magnetic body sheets are laminated. In the multilayer body 125, a coil conductor B52, a coil conductor (first coil conductor) B51, a coil conductor (second coil conductor) A51, and a coil conductor A52 are embedded, each of which preferably has a band shape, for example.

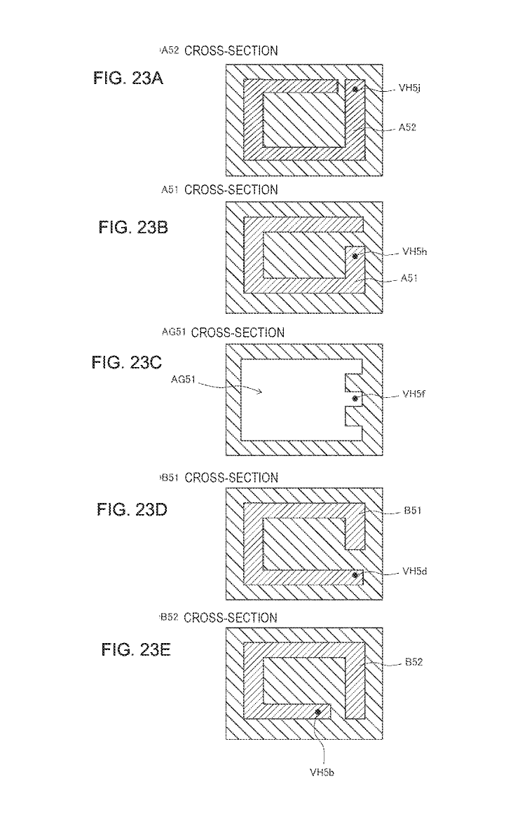

As shown in FIGS. 23A through 23E, preferably, the coil conductors A52, A51, B51, and B52 have the same or substantially the same line width and outer shape, are aligned or substantially aligned in the lamination direction in that order, and are connected in series through via hole conductors VH5j, VH5h, VH5f, and VH5d. With this configuration, a coil CIL05 is provided. At least the coil conductors A51 and B51 define a circle when viewed in the lamination direction. The coil CIL05 is embedded in the multilayer body 125 such that a winding axis thereof preferably extends in the lamination direction. One end of the coil CIL05 communicates with the exterior of the multilayer body 125 through a via hole conductor VH5b, while the other end of the CIL05 communicates with the exterior of the multilayer body 125 through a via hole conductor (not shown).

An air gap AG51 is provided at a central position in the lamination direction. More specifically, preferably, the air gap AG51 is provided in a region surrounded by an inner circumferential edge of the circle defined by the coil conductors A51 and B51 when viewed in the lamination direction, and is further provided in a region where the coil conductors A51 and B51 overlap each other when viewed in the lamination direction. A distance from the air gap AG51 to the coil conductor A51 in the lamination direction is preferably equal or substantially equal to a distance from the air gap AG51 to the coil conductor B51 in the lamination direction, for example. Further, the AG51 is sandwiched between the coil conductors B51 and A51, and the coil conductors B51 and A51 are surrounded by the magnetic body layers without being exposed to the air gap AG51.

FIG. 23A illustrates an A52 cross-section of the multilayer body 125 at a height position at which the coil conductor A52 is present, FIG. 23B illustrates an A51 cross-section of the multilayer body 125 at a height position at which the coil conductor A51 is present, and FIG. 23C illustrates an AG51 cross-section of the multilayer body 125 at a height position at which the air gap AG51 is present. Further, FIG. 23D illustrates a B51 cross-section of the multilayer body 125 at a height position at which the coil conductor B51 is present, and FIG. 23E illustrates a B52 cross-section of the multilayer body 125 at a height position at which the coil conductor B52 is present.

In the present preferred embodiment, because the air gap AG51 also extends to a region where the coil conductors A51 and B51 overlap each other, the generation of a crack during calcination is effectively reduced or prevented while improving the direct-current superposition characteristics. A size of the air gap AG51 may be equal to or smaller than an outer shape of the region where the coil conductors A51 and B51 overlap each other when viewed in the lamination direction.

### Sixth Preferred Embodiment

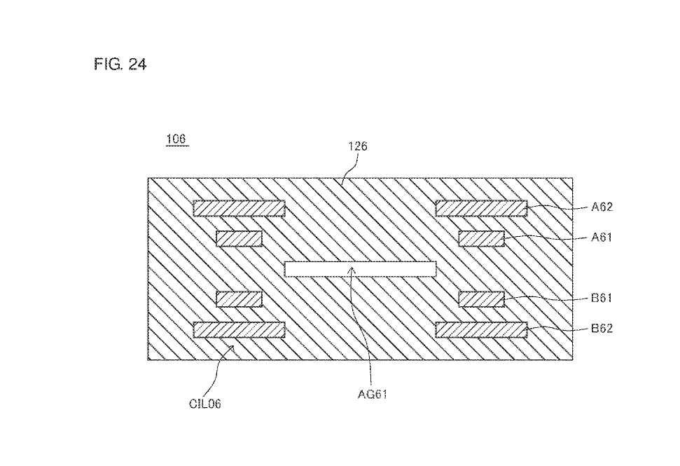

Referring to FIG. 24, a lamination coil component (LGA inductor) 106 according to a sixth preferred embodiment preferably includes a multilayer body 126 in which a plurality of magnetic body sheets are laminated. In the multilayer body 126, a coil conductor B62, a coil conductor (first coil conductor) B61, a coil conductor (second coil conductor) A61, and a coil conductor A62 are embedded, each of which preferably has a band shape, for example.

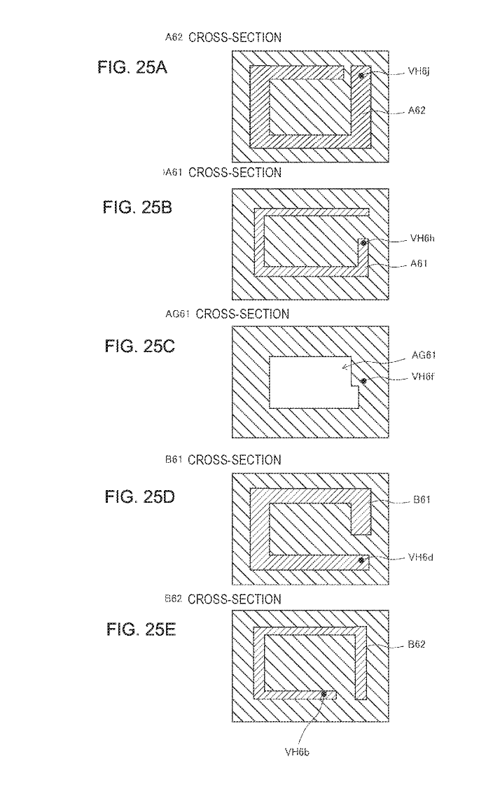

As shown in FIGS. 25A through 25D, preferably, the coil conductors A62, A61, B61, and B62 have different line widths and outer shapes, are aligned in the lamination direction in that order, and are connected in series through via hole conductors VH6j, VH6h, VH6f, VH6d, and VH6b. With this configuration, a coil CIL06 is provided. At least the coil conductors A61 and B61 define a circle when viewed in the lamination direction. The coil CIL06 is embedded in the multilayer body 126 such that a winding axis thereof preferably extends in the lamination direction. One end of the coil CIL06 communicates with the exterior of the multilayer body 126 through the via hole conductor VH6b, while the other end of the CIL06 communicates with the exterior of the multilayer body 126 through a via hole conductor (not shown).

An air gap AG61 is provided at a central position in the lamination direction. More specifically, the air gap AG61 is preferably provided in a region surrounded by an inner circumferential edge of the circle drawn by the coil conductors A61 and B61 when viewed in the lamination direction. A distance from the air gap AG61 to the coil conductor A61 in the lamination direction is preferably equal or substantially equal to a distance from the air gap AG61 to the coil conductor B61 in the lamination direction, for example. Further, the air gap AG61 is positioned between the coil conductors B61 and A61 in the lamination direction, and the coil conductors B61 and A61 are surrounded by the magnetic body without being exposed to the air gap AG61.

FIG. 25A illustrates an A62 cross-section of the multilayer body 126 at a height position at which the coil conductor A62 is present, FIG. 25B illustrates an A61 cross-section of the multilayer body 126 at a height position at which the coil conductor A61 is present, and FIG. 25C illustrates an AG61 cross-section of the multilayer body 126 at a height position at which the air gap AG61 is present. Further, FIG. 25D illustrates a B61 cross-section of the multilayer body 126 at a height position at which the coil conductor B61 is present, and FIG. 25E illustrates a B62 cross-section of the multilayer body 126 at a height position at which the coil conductor B62 is present.

In the present preferred embodiment, because the coil conductors A62, A61, B61, and B62 have different line widths and outer shapes, fine adjustment is able to be made to the inductance value of the coil CIL06. In addition, even if the coil conductors A62, A61, B61, and B62 are slightly shifted in a plane surface direction at the time of lamination, opposing areas between the coil conductors are unlikely to change so that a value of stray capacitance generated between the coil conductors is unlikely to vary. Accordingly, a variation in the characteristics due to the positional shifts at the time of lamination is unlikely to occur.

### Seventh Preferred Embodiment

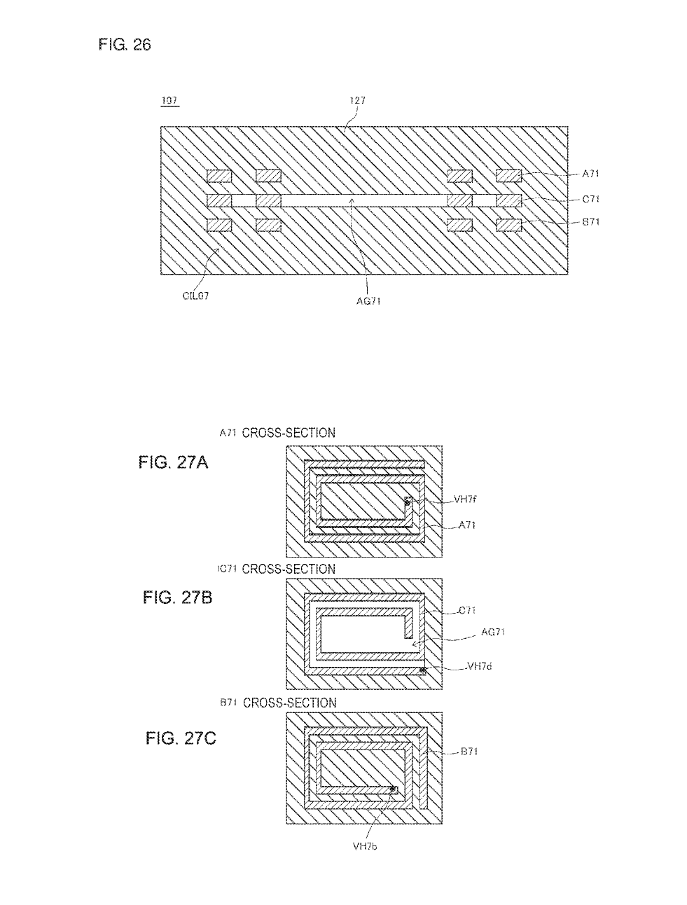

Referring to FIG. 26, a lamination coil component (LGA inductor) 107 according to a seventh preferred embodiment preferably includes a multilayer body 127 in which a plurality of magnetic body sheets are laminated. In the multilayer body 127, a coil conductor (first coil conductor) B71, a coil conductor (additional coil conductor) C71, and a coil conductor (second coil conductor) A71 are embedded, each of which preferably has a band shape, for example.

As shown in FIGS. 27A through 27C, preferably, the coil conductors A71, C71, and B71 have the same or substantially the same line width and outer shape, have a spiral form, and are aligned or substantially aligned in the lamination direction in that order. In addition, the coil conductors A71, C71, and B71 are connected in series through via hole conductors VH7f, VH7d, and VH7b. With this, a coil CIL07 is provided. The coil CIL07 is embedded in the multilayer body 127 such that a winding axis thereof preferably extends in the lamination direction. One end of the coil CIL07 communicates with the exterior of the multilayer body 127 through the via hole conductor VH7b, while the other end of the CIL07 communicates with the exterior of the multilayer body 127 through a via hole conductor (not shown).

An air gap AG71 is provided at a central position in the lamination direction, i.e., at the same or substantially the same height position as the coil conductor C71. More specifically, preferably, the air gap AG71 is provided in a region where a portion of the coil conductor C71 is excluded from a rectangular region that is circumscribed to the coil conductor C71 when viewed in the lamination direction. A distance from the air gap AG71 (coil conductor C71) to the coil conductor A71 in the lamination direction is preferably equal or substantially equal to a distance from the air gap AG71 (coil conductor C71) to the coil conductor B71 in the lamination direction, for example. Further, the air gap AG71 is positioned between the coil conductors B71 and A71 in the lamination direction, and the coil conductors B71 and A71 are surrounded by the magnetic body without being exposed to the air gap AG71.

In the present preferred embodiment, because the air gap AG71 is provided in a region where a portion of the coil conductor C71 is excluded from a rectangular region that is circumscribed to the coil conductor C71 when viewed in the lamination direction, the total magnetic flux generated by the coil conductors A71, C71 and B71 is effectively blocked or reduced. In addition, since the coil conductors A71, C71, and B71 each have a spiral form, the inductance value is increased.

### Eighth Preferred Embodiment

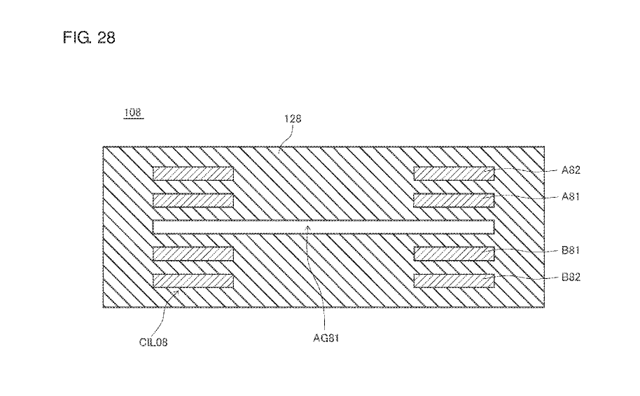

Referring to FIG. 28, a lamination coil component (LGA inductor) 108 according to an eighth preferred embodiment of the present invention preferably includes a multilayer body 128 in which a plurality of magnetic body sheets are laminated. In the multilayer body 128, a coil conductor B82, a coil conductor (first coil conductor) B81, a coil conductor (second coil conductor) A81, and a coil conductor A82 are embedded, each of which preferably has a band shape, for example.

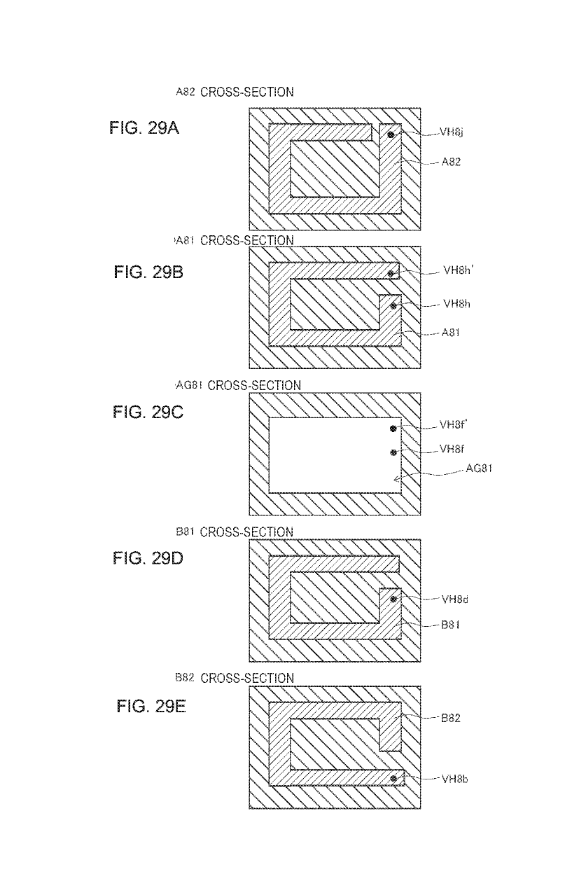

As shown in FIGS. 29A through 29E, preferably, the coil conductors A82, A81, B81, and B82 have different line widths and outer shapes, and are aligned or substantially aligned in the lamination direction in that order. The coil conductor A82 is connected in series to the coil conductor A81 through a via hole conductor VH8j, and the coil conductor B81 is connected in series to the coil conductor B82 through a via hole conductor VH8d. Further, the coil conductor A81 is connected in parallel to the coil conductor B81 through via hole conductors VH8h, VH8h′, VH8f, and VH8f′. Furthermore, the coil conductors A82, A81, B81, and B82 draw a circle when viewed in the lamination direction.

A coil CIL08 structured in the manner discussed above is embedded in the multilayer body 128 such that a winding axis thereof preferably extends in the lamination direction. One end of the coil CIL08 communicates with the exterior of the multilayer body 128 through a via hole conductor VH8b, while the other end of the CIL08 communicates with the exterior of the multilayer body 128 through a via hole conductor (not shown).

An air gap AG81 is provided at a central position in the lamination direction. More specifically, preferably, the air gap AG81 is provided in a region surrounded by an outer circumferential edge of the circle defined by the coil conductors A82, A81, B81, and B82 when viewed in the lamination direction. A distance from the air gap AG81 to the coil conductor A81 is preferably equal or substantially equal to a distance from the air gap AG81 to the coil conductor B81, for example. Further, the AG81 is sandwiched in the lamination direction between the coil conductors B81 and A81, and the coil conductors B81 and A81 are surrounded by the magnetic body layers without being exposed to the air gap AG81.

FIG. 29A illustrates an A82 cross-section of the multilayer body 128 at a height position at which the coil conductor A82 is present, FIG. 29B illustrates an A81 cross-section of the multilayer body 128 at a height position at which the coil conductor A81 is present, and FIG. 29C illustrates an AG81 cross-section of the multilayer body 128 at a height position at which the air gap AG81 is present. Further, FIG. 29D illustrates a B81 cross-section of the multilayer body 128 at a height position at which the coil conductor B81 is present, and FIG. 29E illustrates a B82 cross-section of the multilayer body 128 at a height position at which the coil conductor B82 is present.

In the present preferred embodiment, since the coil conductors A81 and B81 are connected in parallel, a direct-current resistance component of the coil is effectively reduced or prevented.

### Ninth Preferred Embodiment

Referring to FIG. 30, a lamination coil component (LGA inductor) 109 according to a ninth preferred embodiment of the present invention preferably includes a multilayer body 129 in which a plurality of magnetic body sheets are laminated. A coil conductor D92, a coil conductor (first coil conductor) D91, a coil conductor (additional coil conductor) C92, a coil conductor (second coil conductor) B91, a coil conductor (additional coil conductor) C91, a coil conductor (third coil conductor) A91, and a coil conductor A92, each of which preferably has a band shape, are embedded in the multilayer body 129 in that order.

The coil conductors D92, D91, C92, B91, C91, A91, and A92 are connected in series so as to define a single coil CIL09. At least the coil conductors A91, B91, and D91 define a circle when viewed in the lamination direction. The coil CIL09 is embedded in the multilayer body 129 such that a winding axis thereof preferably extends in the lamination direction. One end and the other end of the coil CIL09 are respectively connected to input-output terminals 149a and 149b formed on a lower surface of the multilayer body 129.

An air gap AG91 is provided at the same or substantially the same height position as the coil conductor C91, and an air gap AG92 is provided at the same or substantially the same height position as the coil conductor C92. More specifically, preferably, a thickness of the air gap AG91 is equal or substantially equal to a thickness of the coil conductor C91, and a thickness of the air gap AG92 is equal or substantially equal to a thickness of the coil conductor C92, for example. The coil conductor C91 is exposed to the air gap AG91 on the inner circumferential edge side thereof, and the coil conductor C92 is exposed to the air gap AG92 on the inner circumferential edge side thereof. The air gaps AG91 and AG92 are both provided in a region surrounded by an inner circumferential edge of the circle defined by the coil conductors A91, B91, and D91 when viewed in the lamination direction.

The air gap AG91 is positioned between the coil conductors B91 and A91 in the lamination direction, and the coil conductors B91 and A91 are surrounded by the magnetic body without being exposed to the air gap AG91. Likewise, the air gap AG92 is positioned between the coil conductors D91 and B91 in the lamination direction, and the coil conductors D91 and B91 are surrounded by the magnetic body without being exposed to the air gap AG92.

In the present preferred embodiment, since the two air gaps AG91 and AG92 are provided in the multilayer body 129, the direct-current superposition characteristics are further improved.

### Tenth Preferred Embodiment

Referring to FIG. 31, a lamination coil component (LGA inductor) 1010 according to a tenth preferred embodiment preferably includes a multilayer body 1210 in which a plurality of magnetic body sheets are laminated. A coil conductor B103, a coil conductor B102, a coil conductor (first coil conductor) B101, a coil conductor (additional coil conductor) C102, a coil conductor (additional coil conductor) C101, a coil conductor (second coil conductor) A101, and a coil conductor A102, each of which preferably has a band shape, for example, are embedded in the multilayer body 1210 in that order.

The coil conductors B103, B102, B101, C102, C101, A101, and A102 are connected in series so as to define a single coil CIL10. At least the coil conductors A101 and B101 define a circle when viewed in the lamination direction. The coil CIL10 is embedded in the multilayer body 1210 such that a winding axis thereof preferably extends in the lamination direction. One end and the other end of the coil CIL10 are respectively connected to input-output terminals 1410a and 1410b provided on a lower surface of the multilayer body 1210.

Preferably, an air gap AG101 is provided, at a position next to the coil conductors C101 and C102 in the lamination direction, in a region surrounded by an inner circumferential edge of the circle defined by the coil conductors A101 and B101 when viewed in the lamination direction. The coil conductors C101 and C102 are exposed to the air gap AG101 on their inner circumferential edge sides. Further, the air gap AG101 is preferably positioned between the coil conductors B101 and A101 in the lamination direction, and the coil conductors B101 and A101 are surrounded by the magnetic body layers without being exposed to the air gap AG101.

In the present preferred embodiment, since the air gap AG101 extends across the coil conductors C101 and C102, the direct-current superposition characteristics are further improved.

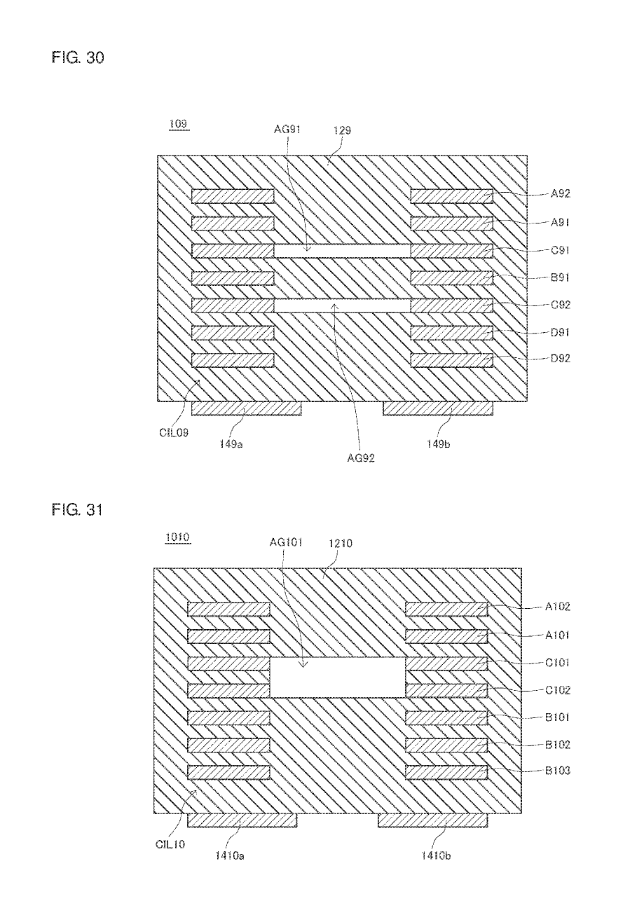

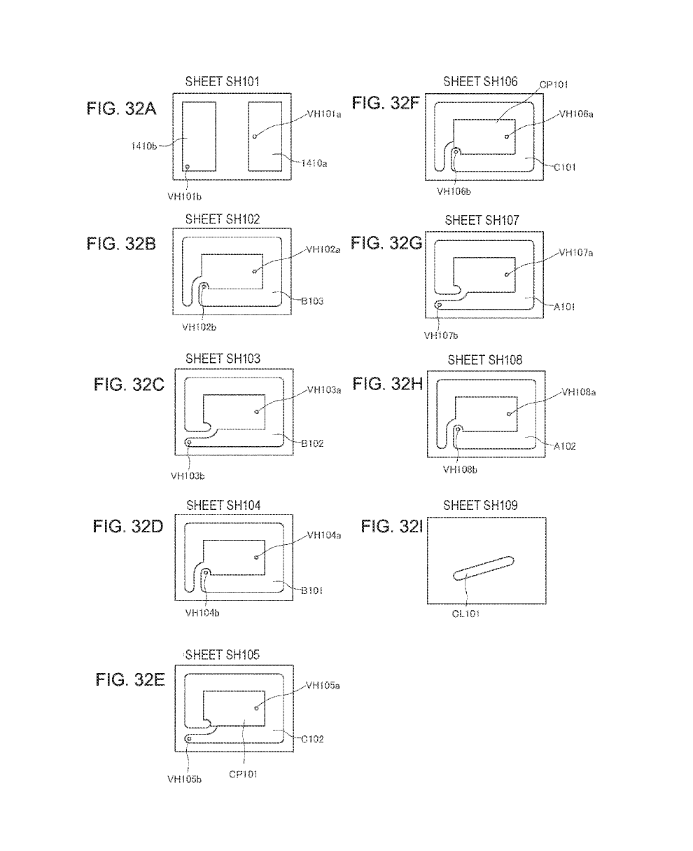

The lamination coil component 1010 according to the present preferred embodiment is preferably manufactured in the following manner, for example. That is, referring to FIGS. 32A through 32I, magnetic green sheets SH101 through SH109 are prepared first, through-holes are formed by laser in the magnetic green sheets SH101 through SH104, SH107, and SH108 at predetermined positions, and then the through-holes having been formed are filled with a conductive paste.

Through this process, via hole conductors VH101a and VH101b are formed in the magnetic green sheet SH101, via hole conductors VH102a and VH102b are formed in the magnetic green sheet SH102, and via hole conductors VH103a and VH103b are formed in the magnetic green sheet SH103. Further, via hole conductors VH104a and VH104b are formed in the magnetic green sheet SH104, via hole conductors VH107a and VH107b are formed in the magnetic green sheet SH107, and via hole conductors VH108a and VH108b are formed in the magnetic green sheet SH108.

Next, in the manner shown in FIGS. 32A through 32D and FIGS. 32G through 321, a conductive paste is applied onto the magnetic green sheets SH101 through SH104 and SH107 through S109. As a result, the input-output terminals 1410a and 1410b are formed on the magnetic green sheet SH101; the coil conductors B103, B102, B101, A101, and A102 are formed on the magnetic green sheets SH102 through SH104, SH107 and SH108, respectively; and a wiring conductor CL101 is formed on the magnetic green sheet SH109.

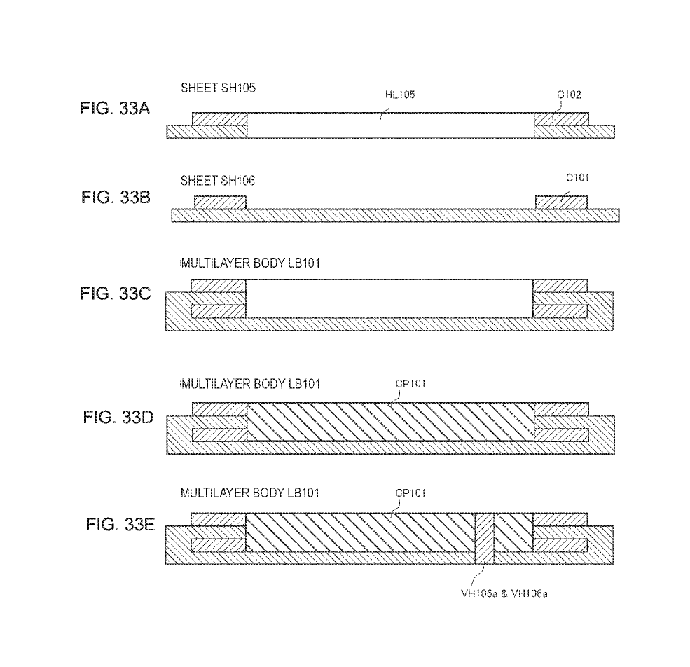

Further, a through-hole HL105 corresponding to the air gap AG101 is formed by laser in the magnetic green sheet SH105, and a conductive paste corresponding to the coil conductor C102 is applied (see FIG. 32E and FIG. 33A). A conductive paste corresponding to the coil conductor C101 is applied onto the magnetic green sheet SH106 (see FIG. 32F and FIG. 33B).

Subsequently, the magnetic green sheet SH105 is laminated and pressure-bonded to the magnetic green sheet SH106 to manufacture a multilayer body LB101 shown in FIG. 33C, and a carbon paste CP101 is filled into a position corresponding to the air gap AG101 in the manner as shown in FIG. 33D.

Thereafter, the multilayer body LB101 is irradiated with a laser beam at a predetermined position to form a through-hole, and the through-hole having been formed is filled with a conductive paste (see FIG. 33E). Through this, via hole conductors VH105a and VH105b are formed at a height position corresponding to the magnetic green sheet SH15 (see FIG. 32E), and via hole conductors VH106a and VH106b are formed at a height position corresponding to the magnetic green sheet SH106 (see FIG. 32F).

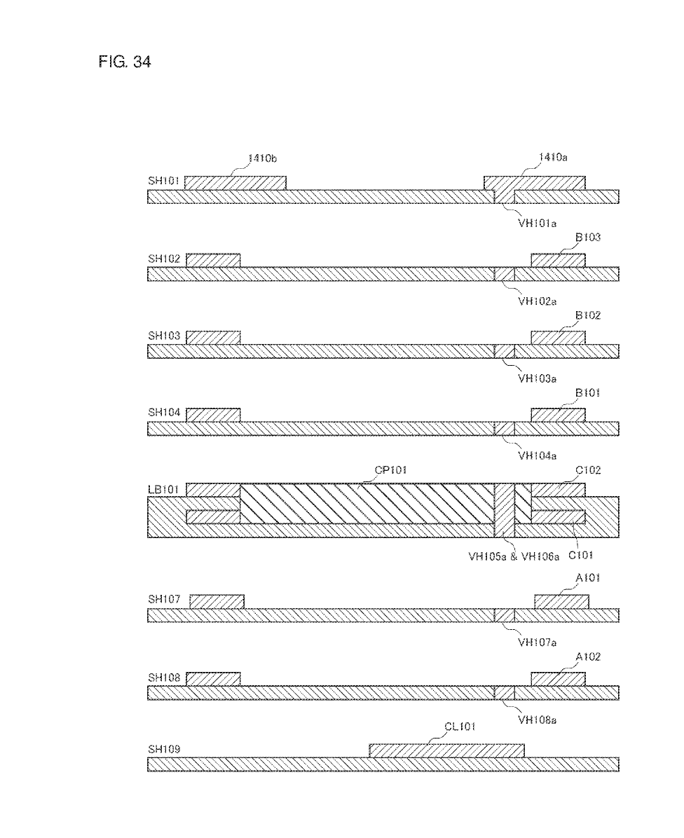

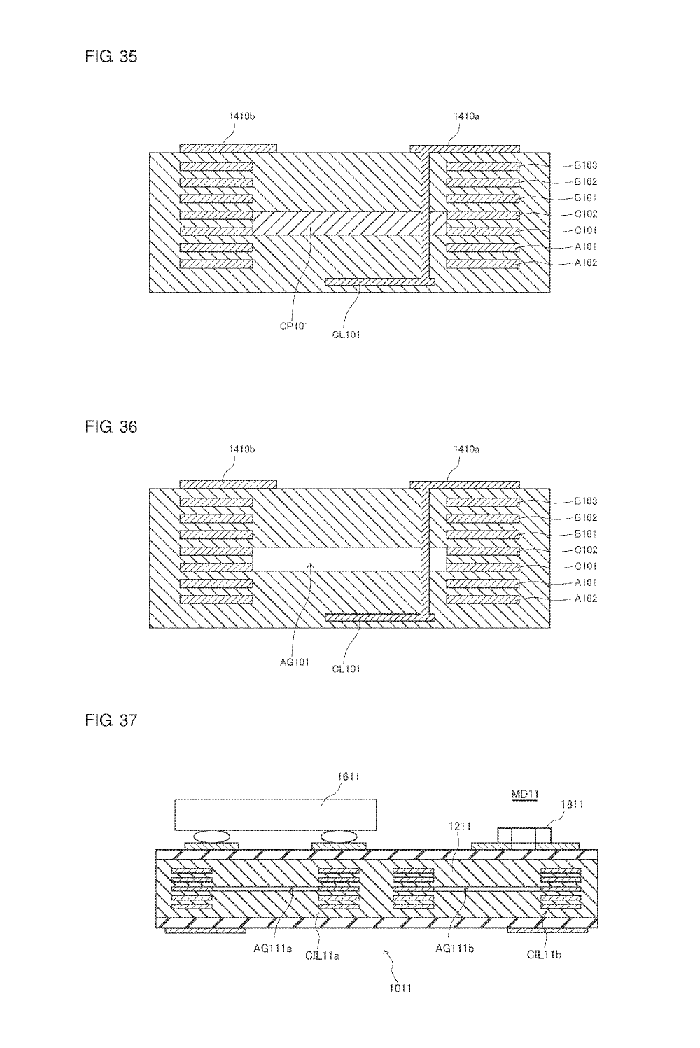

In this manner, when the magnetic green sheets SH101 through SH104, the multilayer body LB101, and the magnetic green sheets SH107 through SH109, as shown in FIG. 34, are obtained, these members are laminated in that order and pressure-bonded together. Through this method, a multilayer body (raw block) shown in FIG. 35 is manufactured. Calcining the raw block causes the magnetic green sheets SH101 through SH109 and the conductive paste to be sintered and further causes the carbon paste CP101 to burn and vanish. As a result, the lamination coil component 1010 including the air gap AG101 is completed in the manner as shown in FIG. 36.

In the above-described first through tenth preferred embodiments of the present invention, although the air gaps thereof have a size that is encompassed within an outer edge of a circle when viewed in the lamination direction of the multilayer body, the air gaps may be provided in a region beyond the outer edge of the circle. However, in order to prevent the generation of a crack, it is preferable for the air gap to have a size that is encompassed within the outer edge of the circle when viewed in the lamination direction of the multilayer body as in the first through tenth preferred embodiments.

Although a single coil is preferably embedded in a multilayer body in the above-described first through tenth preferred embodiments, a plurality of coils may be embedded in the multilayer body.

For example, according to FIG. 37, coils CIL11a and CIL11b having different winging axes from one another are embedded in a multilayer body 1211 that defines a lamination coil component (DC-DC converter) 1011. Both of the winding axes of the coil CIL11a and coil CIL11b preferably extend in the lamination direction. Preferably, an air gap AG111a is provided in a region surrounded by an inner circumferential edge of a circle defined by the coil CIL11a when viewed in the lamination direction, and at a central position in the lamination direction. Preferably, an air gap AG111b is provided in a region surrounded by an inner circumferential edge of a circle defined by the coil CIL11b when viewed in the lamination direction, and at a central position in the lamination direction.

On an upper surface of the lamination coil component 1011, an integrated circuit 1611 and a capacitor 1811 connected to the coils CIL11a and CIL11b, respectively, are mounted so as to define a coil module MD11.

If the air gaps AG111a and AG111b are not provided, a thickness of a cavity portion of the coil CIL111a or CIL111b is less than a thickness of a conductor portion of the coil CIL111a or CIL111b, and unevenness is likely to be generated on a surface of the multilayer body 1211 after calcination. However, in the case where the air gaps AG111a and AG111b are provided, unevenness is reduced or prevented by the carbon paste applied to the gaps. This advantage is particularly prominent in the case where other components are mounted on the upper surface of the lamination coil component 1011.

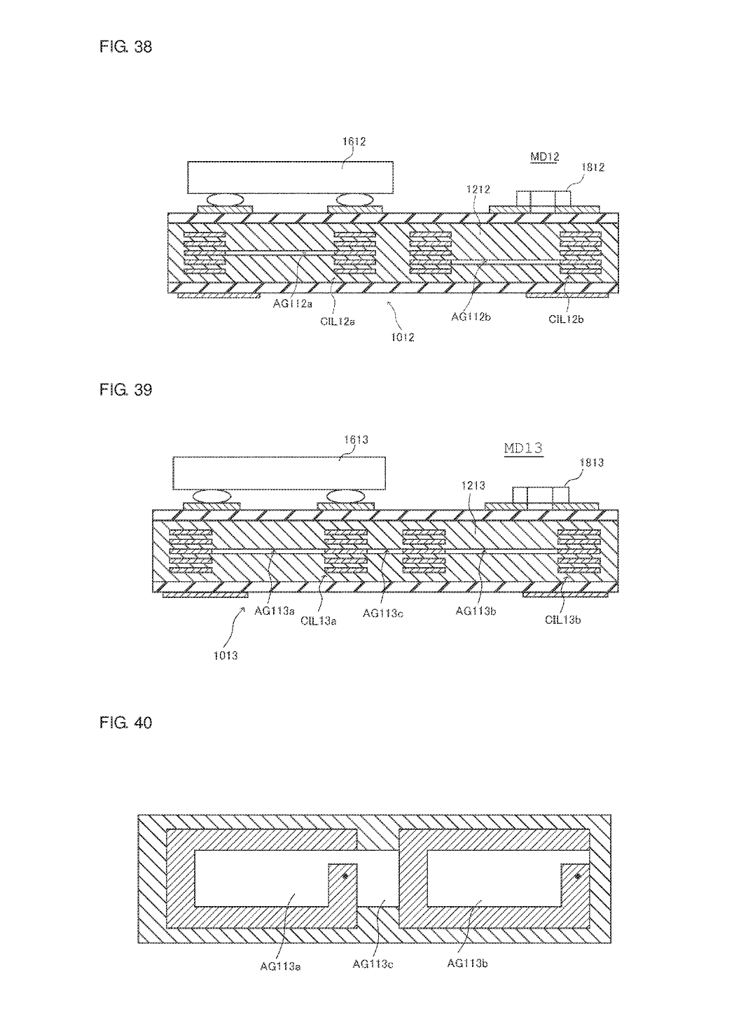

Further, according to FIG. 38, coils CIL12a and CIL12b having different winging axes from one another are preferably embedded in a multilayer body 1212 defining a lamination coil component (DC-DC converter) 1012. Both of the winding axes of the coil CIL12a and coil CIL12b preferably extend in the lamination direction. An air gap AG112a is preferably provided in a region surrounded by an inner circumferential edge of a circle defined by the coil CIL12a when viewed in the lamination direction, and at a central position in the lamination direction. An air gap AG112b is preferably provided in a region surrounded by an inner circumferential edge of a circle defined by the coil CIL12b when viewed in the lamination direction, and at a slightly lower position than a central position in the lamination direction.

On an upper surface of the lamination coil component 1012, an integrated circuit 1612 and a capacitor 1812 connected to the coils CIL12a and CIL12b, respectively, are mounted, and a coil module MD12 is thus provided.

As in this lamination coil component 1012, by changing the air gap formation positions between the air gaps AG112a and AG112b, the inductance values of the coil CIL12a and CIL12b are able to be different from each other.

Furthermore, according to FIG. 39, coils CIL13a and CIL13b having different winging axes from one another are preferably embedded in a multilayer body 1213 defining a lamination coil component (DC-DC converter) 1013. Both the winding axes of the coil CIL13a and coil CIL13b preferably extend in the lamination direction.

An air gap AG113a is preferably provided in a region surrounded by an inner circumferential edge of a circle defined by the coil CIL13a when viewed in the lamination direction, and at a central position in the lamination direction. An air gap AG113b is preferably provided in a region surrounded by an inner circumferential edge of a circle defined by the coil CIL13b when viewed in the lamination direction, and at a central position in the lamination direction. In addition, an air gap AG113c is preferably provided at a position sandwiched between the coils CIL13a and CIL13b when viewed in the lamination direction, and at a central position in the lamination direction. As shown FIG. 40, the air gap AG113c communicates with the air gap AG113a.

On an upper surface of the lamination coil component 1013, an integrated circuit 1613 and a capacitor 1813 connected to the coils CIL13a and CIL13b, respectively, are mounted and define a coil module MD13.

As in the lamination coil component 1013, providing and additional air gap AG113c further improves the direct-current superposition characteristics. Moreover, a crack is unlikely to be generated during calcination because the air gap AG113c is provided between the coils CIL13a and CIL13b.

Although the above-described first through tenth preferred embodiments have different features from the basic structure shown in FIG. 1, these features can arbitrarily be combined as long as such features do not conflict with each other. For example, in the tenth preferred embodiment (see FIG. 31), the single air gap AG101 is provided at a position next to the coil conductors C101 and C102. However, by combining the features of the ninth preferred embodiment shown in FIG. 30, a plurality of air gaps respectively next to a plurality of coil conductors may be provided in a multilayer body.

Further, the structures of the coil modules MD11 through MD13 shown in FIGS. 37 through 39, respectively, can be appropriately modified in view of the features included in the first through tenth preferred embodiments.

In the above preferred embodiments aside from the ninth preferred embodiment, although the air gaps are provided in the vicinity of the center in the lamination direction, the air gaps are not limited to the above-mentioned position and may be provided at any suitable position in the lamination direction within the scope and spirit of the invention.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A lamination coil component comprising:
a multilayer body including a plurality of magnetic body layers that are laminated in a lamination direction; and
a coil that is embedded in the multilayer body such that a winding axis of the coil extends in the lamination direction; wherein
the coil includes a plurality of coil conductors that are respectively provided in the plurality of magnetic body layers so as to define a circle when viewed in the lamination direction;
an air gap is provided in a region surrounded by an inner circumferential edge of the circle defined by the plurality of coil conductors when viewed in the lamination direction;
the plurality of coil conductors include first and second coil conductors respectively positioned on upper and lower sides of the air gap in the lamination direction;
the first and second coil conductors are surrounded by the magnetic body layers without being exposed to the air gap; and
the air gap extends to a position that overlaps with a portion of at least one of the first and second coil conductors when viewed in the lamination direction.

2. The lamination coil component according to claim 1, wherein the plurality of coil conductors include at least one additional coil conductor provided at a position overlapping with the air gap in the lamination direction.

3. The lamination coil component according to claim 2, wherein the at least one additional coil conductor is exposed to the air gap on an inner circumferential edge side of the at least one additional coil conductor.

4. The lamination coil component according to claim 2, wherein the at least one additional coil conductor is exposed to the air gap in the lamination direction.

5. The lamination coil component according to claim 1, wherein the air gap has a size that is encompassed within an outer edge of the circle when viewed in the lamination direction.

6. The lamination coil component according to claim 1, wherein distances from each of the first and second coil conductors to the air gap in the lamination direction are equal or substantially equal to each other.

7. The lamination coil component according to claim 1, wherein the air gap is provided at a plurality of different positions in the lamination direction.

8. A lamination coil component comprising:
a multilayer body including a plurality of magnetic body layers that are laminated in a lamination direction; and
a coil that is embedded in the multilayer body such that a winding axis of the coil extends in the lamination direction; wherein
the coil includes a plurality of coil conductors that are respectively provided in the plurality of magnetic body layers so as to define a circle when viewed in the lamination direction;
an air gap is provided in a region surrounded by an inner circumferential edge of the circle defined by the plurality of coil conductors when viewed in the lamination direction;
the plurality of coil conductors include first and second coil conductors respectively positioned on upper and lower sides of the air gap in the lamination direction;
the first and second coil conductors are surrounded by the magnetic body layers without being exposed to the air gap; and
the air gap is provided next to two or more of the plurality of coil conductors that are positioned between the first and second coil conductors.

9. The lamination coil component according to claim 8, wherein the plurality of coil conductors include at least one additional coil conductor provided at a position overlapping with the air gap in the lamination direction.

10. The lamination coil component according to claim 9, wherein the at least one additional coil conductor is exposed to the air gap on an inner circumferential edge side of the at least one additional coil conductor.

11. The lamination coil component according to claim 9, wherein the at least one additional coil conductor is exposed to the air gap in the lamination direction.

12. The lamination coil component according to claim 8, wherein the air gap has a size that is encompassed within an outer edge of the circle when viewed in the lamination direction.

13. A lamination coil component comprising:
a multilayer body including a plurality of magnetic body layers that are laminated in a lamination direction; and
a plurality of coils that are embedded in the multilayer body such that a winding axis of each of the plurality of coils extends in the lamination direction; wherein
each of the plurality of coils includes a plurality of coil conductors that are respectively provided in the plurality of magnetic body layers so as to define a circle when viewed in the lamination direction;
an air gap is provided in a region surrounded by an inner circumferential edge of the circle defined by the plurality of coil conductors when viewed in the lamination direction;
the plurality of coil conductors include first and second coil conductors respectively positioned on upper and lower sides of the air gap in the lamination direction;
the first and second coil conductors are surrounded by the magnetic body layers without being exposed to the air gap;
the plurality of coils have different winding axes from one another; and
distances from a central position of the plurality of coils to the air gap in the lamination direction are different from one another.

14. The lamination coil component according to claim 13, wherein the plurality of coil conductors of at least one of the plurality of coils include at least one additional coil conductor provided at a position overlapping with the air gap in the lamination direction.

15. The lamination coil component according to claim 14, wherein the at least one additional coil conductor is exposed to the air gap on an inner circumferential edge side of the at least one additional coil conductor.

16. The lamination coil component according to claim 14, wherein the at least one additional coil conductor is exposed to the air gap in the lamination direction.

17. A lamination coil component comprising:
a multilayer body including a plurality of magnetic body layers that are laminated in a lamination direction; and
a plurality of coils that are embedded in the multilayer body such that a winding axis of each of the plurality of coils extends in the lamination direction; wherein
each of the plurality of coils includes a plurality of coil conductors that are respectively provided in the plurality of magnetic body layers so as to define a circle when viewed in the lamination direction;
an air gap is provided in a region surrounded by an inner circumferential edge of the circle defined by the plurality of coil conductors when viewed in the lamination direction;
the plurality of coil conductors include first and second coil conductors respectively positioned on upper and lower sides of the air gap in the lamination direction;
the first and second coil conductors are surrounded by the magnetic body layers without being exposed to the air gap;
the plurality of coils have different winding axes from one another; and
the multilayer body includes another air gap between the plurality of coils when viewed in the lamination direction.

18. The lamination coil component according to claim 17, wherein the plurality of coil conductors of at least one of the plurality of coils include at least one additional coil conductor provided at a position overlapping with the air gap in the lamination direction.

19. The lamination coil component according to claim 18, wherein the at least one additional coil conductor is exposed to the air gap on an inner circumferential edge side of the at least one additional coil conductor.

20. The lamination coil component according to claim 18, wherein the at least one additional coil conductor is exposed to the air gap in the lamination direction.
